(19) United States
(12) Patent Application Publication
(10) Pub. No.: US 2021/0324672 A1
(43) Pub. Date: Oct. 21, 2021

(54) Pet Access System

(71) Applicant: The Chamberlain Group, Inc., Oak Brook, IL (US)

(72) Inventors: Ayse Beril Altiner, Hinsdale, IL (US); Casparus Cate, Chicago, IL (US); Anna Demirgian-Ebner, Lombard, IL (US); Lucas Michael Enright, Willowbrook, IL (US); Ian Ferguson, Cincinnati, OH (US); Abhinav Garg, Cincinnati, OH (US); Benjamin David Hunt, Elmhurst, IL (US); Kathryn Lawson, Cincinnati, OH (US); Elaine Messerly, Cincinnati, OH (US); David R. Morris, Glenview, IL (US); Robert John Olmsted, Wood Dale, IL (US); Prakanth Prasad, Cincinnati, OH (US); David Schuda, Wheaton, IL (US); Grace Widmeyer, Downers Grove, IL (US)

(21) Appl. No.: 17/234,565

(22) Filed: Apr. 19, 2021

Related U.S. Application Data
(60) Provisional application No. 63/012,600, filed on Apr. 20, 2020.

(51) Int. Cl. E05F 15/76; A01K 11/00; E05B 47/00; G07C 9/28

(52) U.S. Cl. CPC E05F 15/76; A01K 11/006; E05F 2015/767; G07C 9/28; E05B 47/0001

(57) ABSTRACT

In one aspect, a pet access apparatus including an actuator and a pet door movable between a closed position and an open position. The pet access apparatus includes communication circuitry to receive a signal indicative of proximity of a pet to the pet door. The pet access apparatus includes an interior camera, an exterior camera, and a processor operably coupled to the actuator, the communication circuitry, the interior camera, and the exterior camera. The processor is configured to determine an attempt by the pet to operate the pet door based at least in part on the proximity of the pet to the pet door, the interior image data, and the exterior image data. The processor is further configured to facilitate movement of the pet door from the closed position toward the open position upon the determination of the attempt by the pet to operate the pet door.

### CROSS-REFERENCE TO RELATED APPLICATION

This application claims the benefit of U.S. Provisional Patent Application No. 63/012,600, filed Apr. 20, 2020, entitled PET ACCESS SYSTEM, which is hereby incorporated by reference in its entirety herein.

### FIELD

This disclosure relates to doors and, in particular, to a door including a pet door.

### BACKGROUND

Many pet owners let their pets outside to get exercise, urinate, etc. Pet owners may not always be present or available to let their pets outside or back indoors. This occurs, for example, when the pet owner is at work or during the night when the pet owner is sleeping.

To address these situations, some have installed pet doors in their homes to allow a pet to enter and exit a home without the need for the owner to be present. Pet doors are known that include a flap that is installed on a lower portion of a door that allows pets to enter and exit a home. However, these pet doors may allow any animal to enter or exit through the door, including wild animals or other pets. Moreover, installing these flap doors may affect the resale value of a home, particularly when selling to buyers who do not own pets.

Other pet doors include a motor that opens the pet door. These pet door systems often include an RFID tag affixed to the pet that communicate with an RFID reader of the pet door. When the RFID reader detects the RFID tag of the pet, the pet door may be opened via the motor. However, the pet door may be opened every time the pet is near the pet door, even if the pet is walking by or sleeping near the door and does not desire to pass through the pet door. The pet door may thereby be opened unnecessarily which may adversely impact the owner's utility bills. Moreover, other animals (such as wild animals) or unauthorized pets may pass through the pet door when the pet door is open.

### BRIEF DESCRIPTION OF THE DRAWINGS

FIG. 1 shows an example of a door including a pet door within a home;

FIG. 2 is an example block diagram of a system associated with the door of FIG. 1;

FIG. 3 is an example flow diagram showing the communication of information between various components of the system of FIG. 2;

FIG. 4 is an example block diagram of the door of FIG. 1;

FIG. 5 shows external components of the door of FIG. 1;

FIG. 6 shows internal components of the door of FIG. 1;

FIGS. 7A-E are example schematic diagrams for powering the door of FIG. 1, FIG. 7B having a partial cutaway to show an interior drive mechanism of the door;

FIGS. 8A and 8B show a door including a pet door according to a first embodiment;

FIGS. 8C and 8D are cross sectional views of the door taken across lines 8C-8C and 8D-8D in FIGS. 8A and 8B;

FIGS. 9A and 9B show a door including a pet door according to a second embodiment;

FIGS. 9C and 9D are cross sectional views of the door taken across lines 9C-9C and 9D-9D in FIGS. 9A and 9B;

FIGS. 10A and 10B show a door including a pet door according to a third embodiment;

FIGS. 10C, 10D, and 10E are cross sectional views of the door taken across lines 10C-10C, 10D-10D, and 10E-10E in FIGS. 10A and 10B;

FIG. 10F is a cross sectional view similar to FIG. 10E;

FIG. 10G shows an example pet door closing system for use with the door of FIGS. 10A-F.

FIGS. 11A and 11B show a door including a pet door according to a fourth embodiment;

FIGS. 11C and 11D are cross sectional views of the door taken across lines 11C-11C and 11D-11D in FIGS. 11A and 11B;

FIG. 11E is a cross sectional view similar to FIG. 11D;

FIGS. 12A and 12B show a door including a pet door according to a fifth embodiment;

FIGS. 12C and 12D are cross sectional views of the door taken across lines 12C-12C and 12D-12D in FIGS. 12A and 12B;

FIGS. 13A and 13B show a door including a pet door according to a sixth embodiment;

FIGS. 13C and 13D are cross sectional views of the door taken across lines 13C-13C and 13D-13D in FIGS. 13A and 13B;

FIGS. 14A and 14B show a door including a pet door according to a seventh embodiment;

FIGS. 14C and 14D are cross sectional views of the door taken across lines 14C-14C and 14D-14D in FIGS. 14A and 14B;

FIG. 15 shows an example motor that may be used to move the pet door of FIG. 1 and FIGS. 8A-14D.

FIG. 16 shows an example linear actuator that may be used to move the pet door of FIG. 1 and FIGS. 8A-14D.

FIG. 17 shows an example pet door and associated hardware for use with the door of FIG. 1;

FIG. 18 shows a portion of the pet door and associated hardware of FIG. 17;

FIG. 19 is an example block diagram of a pet collar device of the system of FIG. 2;

FIG. 20 is an example block diagram of a user device of the system of FIG. 2;

FIGS. 21A-D show screenshots of an example application associated with the door of FIG. 1;

FIGS. 22A-E show example notification features of the application of FIGS. 21A-D;

FIGS. 23A-B show example scheduling and monitoring features of the application of FIGS. 21A-D; and

FIG. 24 is an example block diagram of a remote computer of the system of FIG. 2.

### DETAILED DESCRIPTION

In one aspect of the present disclosure, a pet access apparatus for a door is provided. The pet access apparatus includes a pet door movable between a closed position and an open position and an actuator coupled to the pet door. The pet access apparatus includes communication circuitry to receive a signal indicative of proximity of a pet to the pet door. The pet access apparatus includes an interior camera operable to capture interior image data and an exterior camera operable to capture exterior image data. The pet access apparatus includes a processor operably coupled to the actuator, the communication circuitry, the interior camera, and the exterior camera. The processor is configured to determine an attempt by the pet to operate the pet door based at least in part on the proximity of the pet to the pet door, the interior image data, and the exterior image data. The processor is further configured to facilitate movement of the pet door from the closed position toward the open position upon the determination of the attempt by the pet to operate the pet door. In one described example, the processor is configured to determine whether there is a particular condition (e.g., a presence of a predator, a presence of an unauthorized or unknown animal, precipitation, an open gate, a wet yard, and a muddy yard) outside the pet door based at least in part on the exterior image data. In response to the particular condition being present outside of the pet door, the processor may disregard the attempt by the pet to operate the pet door.

In another aspect, a method of operating a pet access apparatus of a door is provided. The method includes receiving a signal indicative of a proximity of a pet to a pet door of the pet access apparatus via communication circuitry, capturing interior image data via an interior camera, and capturing exterior image data via an exterior camera. The method further includes determining, by a processor, an attempt by the pet to operate the pet door based at least in part on the proximity of the pet to the pet door, the interior image data, and the exterior image data. The method includes facilitating, by the processor, movement of the pet door from the closed position toward the open position upon the attempt by the pet to operate the pet door. In one example, the method includes determining based on the exterior image data whether a particular condition is present outside of the pet door and, in response to determining the particular condition is present outside of the door, disregarding the attempt by the pet to operate the pet door.

In another aspect, a door assembly is provided including a door having an exterior surface, an interior surface, and an opening extending between the exterior surface and the interior surface. The door includes a pocket intermediate the exterior surface and the interior surface of the door, with the pocket in communication with the opening. The door assembly includes a door panel movable between a closed position wherein the door panel closes the opening of the door and an open position wherein the door panel permits movement of a pet through the opening. At least a portion the door panel is received in the pocket of the door with the door panel in the open position. The door assembly includes an actuator operably coupled to the door panel and configured to move the door panel between the closed and open positions. The door assembly includes communication circuitry to receive a signal indicative of a proximity of the pet to the door panel and a camera configured to capture image data relating to the pet. A processor is operably coupled to the actuator, the communication circuitry, and the camera. The processor is configured to determine an attempt by the pet to open the door panel based at least in part on the image data and the proximity of the pet to the door and the image data. The processor is further configured to facilitate movement of the door panel from the closed position toward the open position based at least in part upon the attempt by the pet to open the door panel. In one example, the actuator is operable to shift the door panel horizontally from the closed position toward the open position.

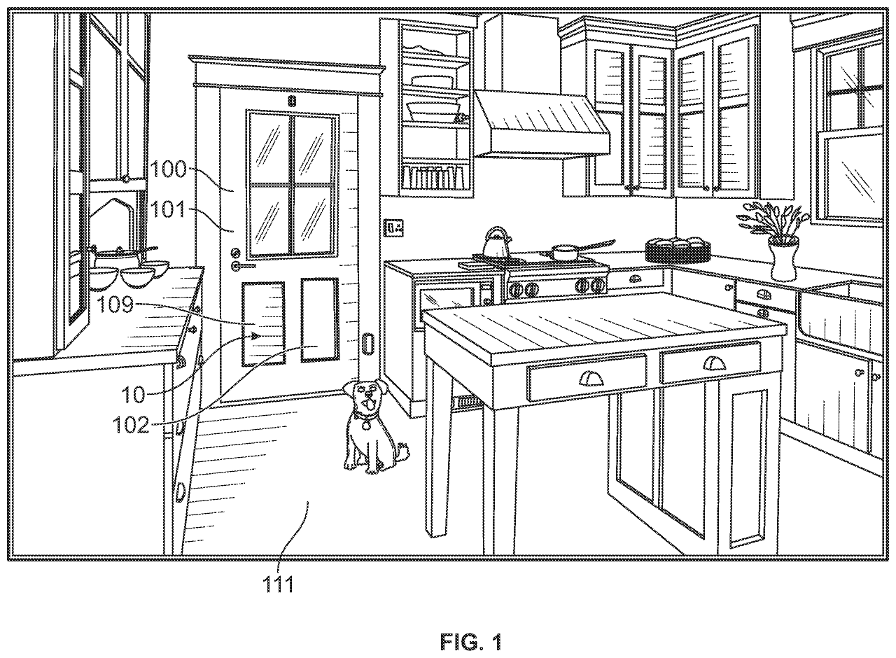

With reference to FIG. 1, in one aspect of the present disclosure, a pet access system is provided that includes a door 100. The door 100 comprises a pet access apparatus 10 including a pet door 102 which may be opened without the physical presence of a pet owner. The state of the pet door 102 may be controlled, for example, by a motor or linear actuator. As shown in FIG. 1, the pet door 102 may be unitary with the door 100 of a home. The door 100 may, for example, be an interior door (e.g. separating one interior room from another) or an exterior door (e.g. a passageway door from the garage or outside area) of the home. As one example, the door 100 may be a front door, backdoor, or side door. The door 100 may be constructed of wood, metal, glass, plastic or various combinations thereof. The door 100 may provide passage into a secured area 111, such as the inside of a home. In FIG. 1, the pet door 102 is in an open position and at least partially within an internal compartment, such as a void or a pocket 105 of the door 100. The pocket 105 may be defined by a body 101 of the door 100 between substantially parallel, planar internal and external surfaces of the body 101. In the open position, an opening is formed in door 100. The pet door 102 closes the opening when in a closed position. The pet door 102 may look visually similar to the rest of the door 100. For example, the pet door 102 may look like another panel of the door, such as panel 109, to conceal the pet door 102.

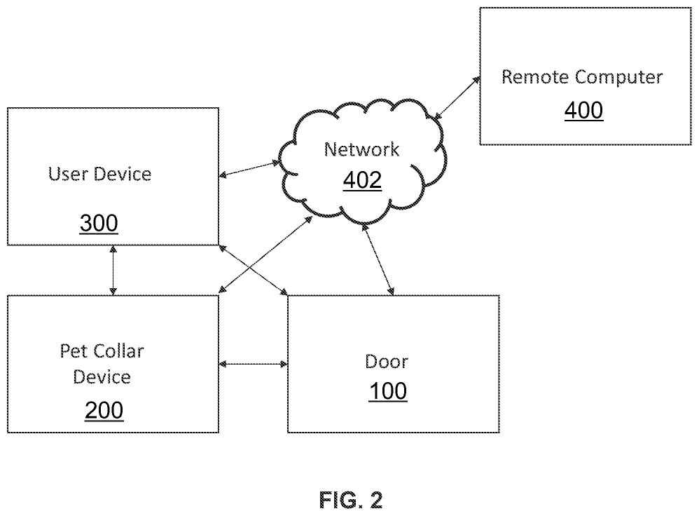

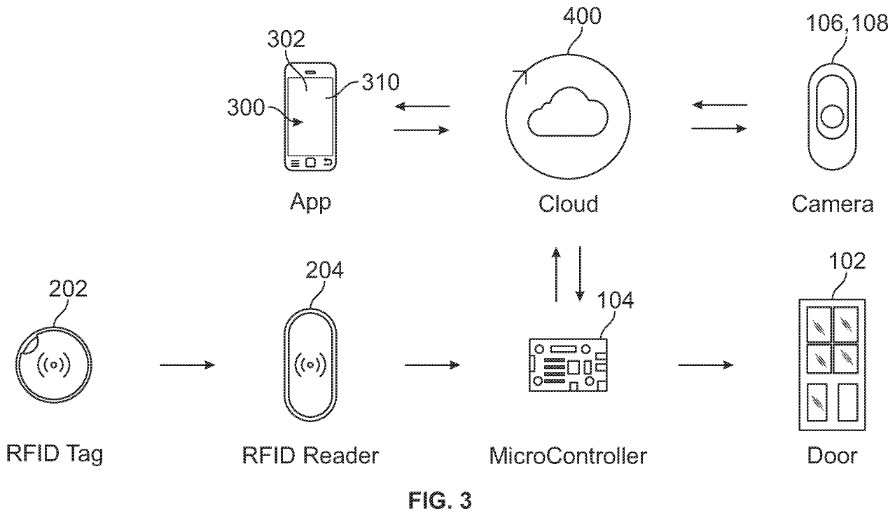

With reference to FIGS. 2 and 3, the pet access apparatus 10 may be in communication with a pet collar device 200. The pet collar device 200 may be a tag and/or collar that the pet wears so that when the pet is near the door 100, the pet door 102 may be opened by detecting or receiving an identification or signature of the pet collar device 200, allowing the pet to pass through the door 102. The pet collar device 200 may alternatively be configured for permanent implantation to the pet (e.g. subcutaneously) similar to a pet identification “microchip” rather than being configured as an object (e.g. collar and/or tag) to be removably worn or carried by the pet. The pet access apparatus 10 and the pet collar device 200 may be able to communicate directly with a user device 300, for example, to set up communication between the pet collar device 200 and the pet access apparatus 10. The user device 300 may include an application 302 associated with a remote computer 400 (e.g. server computer, middleware, or “cloud”) that enables the user device 300 to communicate with the pet access apparatus 10 and/or pet collar device 200. The pet access apparatus 10 and pet collar device 200 may also communicate with the user device 300 via a network 402, e.g., a local Wi-Fi network and the internet. The pet access apparatus 10 and/or pet collar device 200 may, for example, send data to remote computer 400 which communicates data or notifications to the user device 300 via network 402. The pet access apparatus 10 may receive requests from the user device 300 to change a state of the pet door 102 either directly or indirectly via the network 402. The pet access apparatus 10 may include one or more cameras and may communicate information such as images of the interior or exterior of the home to the user device 300 via the network 402. The images may include, for example, still pictures and/or video. The pet access apparatus 10 may also include a microphone 123 and/or speaker 125 to facilitate one or two-way audio communication.

With reference to FIG. 3, the pet collar device 200 may include a radio-frequency identification (RFID) tag 202 that communicates with an RFID reader 204. The RFID tag 202 may be an active RFID tag that continuously or periodically transmits an identification code or signal, or a passive RFID tag that transmits upon being interrogated by the RFID reader 204. The RFID tag reader 204 may be integrated in the door 100 or mounted on the wall near the door 100. The RFID tag reader 204 may receive communication from the RFID tag 202 when the RFID tag 202 is near the door 100. The RFID tag reader 204 may use the strength of the signal received from RFID tag 202 to determine the proximity of the RFID tag 202 to the RFID tag reader 204. When the RFID tag reader 204 receives information from the RFID tag 202, the RFID tag reader 204 may communicate the information to a controller 104 of door 100, such as a microcontroller. The controller 104 may be configured to determine the pet's proximity to the door 100 and/or whether the pet's movements indicates the pet desires to pass through the door 100 based at least in part on the RFID communication.

The controller 104 may change the state of the pet door 102 in response to a determination that the pet is adjacent the door 100. The states of the pet door 102 may include, for example, open, opening, closed, closing, one-way exit, one-way entrance, locked and/or unlocked. The controller 104 may wait to change the state of the pet door 102 until the pet has been proximal to the door 100 for a certain period of time, e.g., 10 seconds. The controller 104 may also employ additional data or output from a sensor or sensors of the pet access apparatus 10 (e.g. interior camera 106 and exterior camera 108) as well as a sensor or sensors of the pet collar device 200 (e.g. gyroscope, accelerometer, positioning device, etc.) to monitor the pet's motion or behavior and determine whether the pet seeks to pass through the pet door 102. The controller 104 may communicate via the network 402. The controller 104 may communicate with and/or send notifications to a user device 300. The user device 300 may run the application 302 associated with door 100 through which a user device 300 displays messages and/or notifications regarding the door 100 (as well as objects and/or areas proximate to the door 100) to the user. The notification may, for example, indicate that the pet is proximal the door 100 and wants to be let out. The controller 104 may communicate with a camera of the door 100, e.g., the interior camera 106 or exterior camera 108. The controller 104 may send control signals to one or both of the cameras 106, 108 to capture an image or video. The controller 104 may communicate with the cameras 106, 108 via the network 402 or directly, e.g., via a wired/wireless connection. The interior and exterior cameras 106, 108 may communicate the captured image data to the controller 104, to the user device 300, and/or the remote computer 400 via network 402.

A user may use the application 302 of the user device 300 to communicate requests or commands (e.g. open/close pet door 102, activate/deactivate camera, etc.) to the controller 104 and/or cameras 106, 108. The user may use a user interface 310 of the user device 300 to input requests and receive information through the application 302. The user may, for example, request the pet door 102 be opened via the application 302. Additionally or alternatively, the user may request a picture or video from the interior and/or exterior cameras 106, 108 via the application 302. The user device 300 may communicate requests via application 302 to the controller 104 and cameras 106, 108 via network 402, e.g., the internet and/or a wide-area network such as WiFi, WiLAN or cellular network.

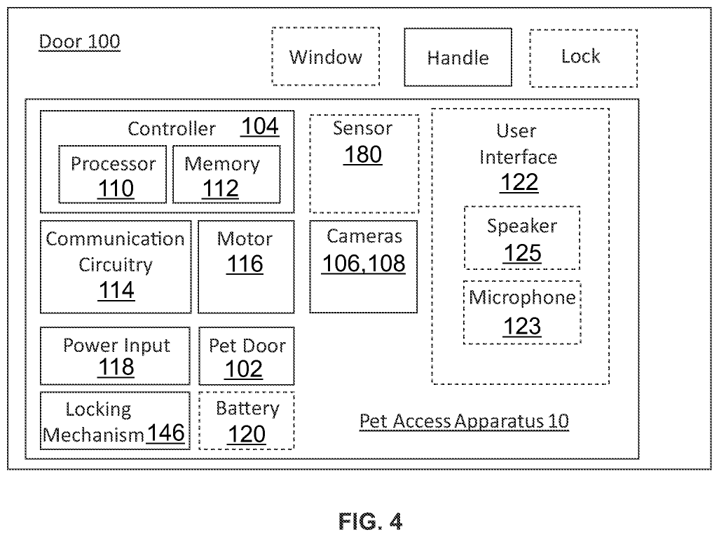

With reference to FIGS. 4-7, the pet access apparatus 10 includes the controller 104 that includes a processor 110 and memory 112. The memory 112 is a non-transitory computer readable media that may store programs, instructions, and information to operate functionality and features of the pet access apparatus 10. The processor 110 is configured to access the memory 112 to receive information from memory 112 and write or store information to memory 112. The processor 110 communicates with the interior camera 106 and exterior camera 108. The processor 110 may receive image data from the cameras 106, 108. The processor 110 may for example, send a control signal to the cameras 106, 108 causing one or both of the cameras 106, 108 to capture images. The camera 106, 108 may capture one or more images and communicate the captured image data to the controller 104 to be processed and/or stored in memory 112. The controller 104 may also communicate some or all of the image data received from the cameras 106, 103 to the remote computer 400 for processing and/or storage.

The controller 104 may be in communication with the communication circuitry 114. The communication circuitry 114 enables the pet access apparatus 10 to communicate with devices external to the door directly and/or indirectly e.g. over network 402. The controller 104 may communicate with the remote computer 400, pet collar device 200, and/or the user device 300 via communication circuitry 114. The communication circuitry 114 may enable the pet access apparatus 10 to communicate over wireless protocols, for example, wireless fidelity (Wi-Fi), cellular, radio frequency (RF), infrared (IR), Bluetooth (BT), Bluetooth Low Energy (BLE), Zigbee, Z-wave and near field communication (NFC). The communication circuitry 114 may include or be in communication with the RFID tag reader 204 capable of reading the RFID tag 202, such as an RFID tag attached to a pet's collar. The communication circuitry 114 may also be in communication with or be configured to communicate with other pet devices, including smart pet feeder or water devices. The communication circuitry 114 may also communicate with a home security system.

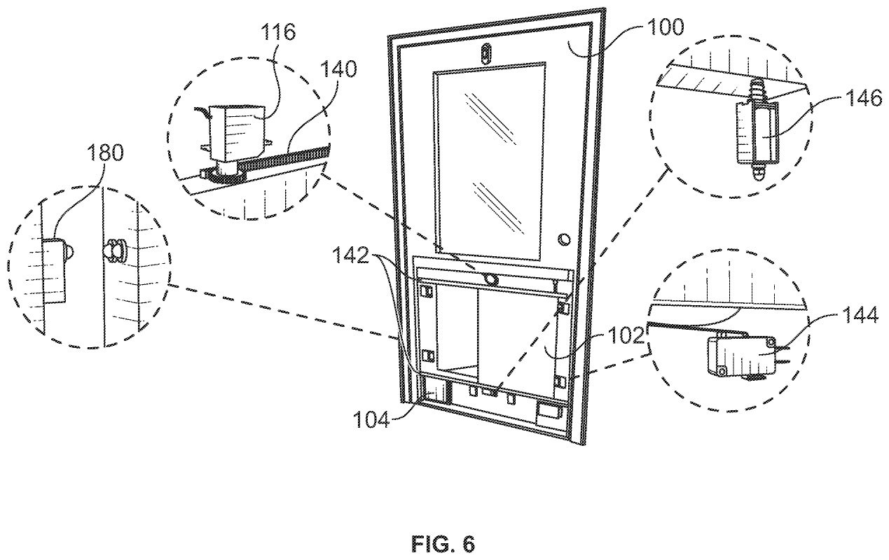

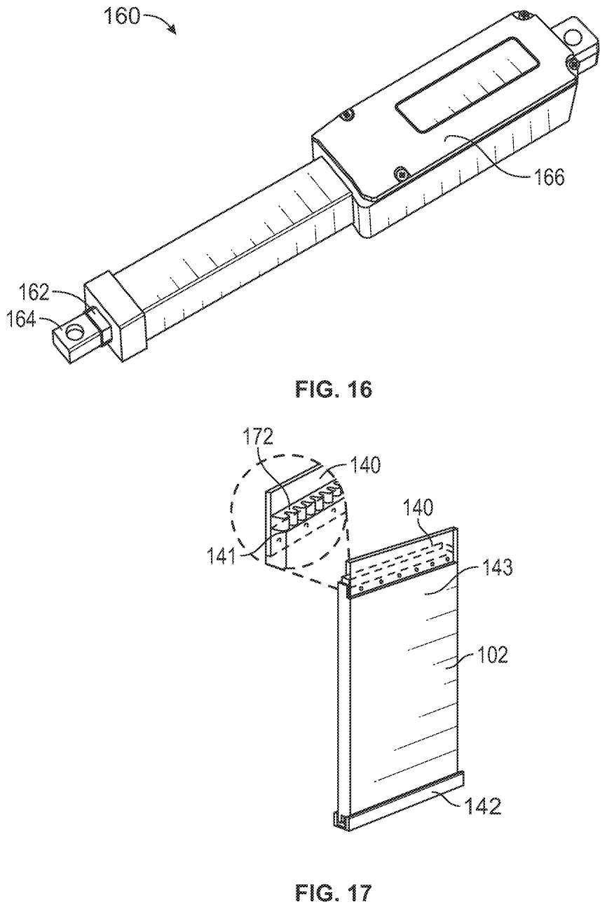

The controller 104 is configured to operate the motor 116. The controller 104 may operate the motor 116 in response to a state change request or command received via the communication circuitry 114 to open/close the pet door 102. The controller 104 may determine to operate the motor 116 independently, for example, based on images captured by the camera and/or communication with the pet collar device 200. The motor 116 may operate in response to a control signal from the controller 104. The motor 116 may be coupled to the pet door 102 to change the state of the pet door 102, i.e., move the pet door 102 to an open or closed position. As shown in FIG. 6, the motor 116 may turn a pinion that engages the complementary teeth of a rack 140 attached to pet door 102. As the motor 116 turns the pinion, movement of the pet door 102 is effectuated. The door 100 may include tracks or rails 142 that guide the pet door 102 when the motor 116 moves pet door 102. Limit switches 144 may be included along the rails 142 or on a portion of the door 100 that indicate to the controller 104 when the pet door 102 has reached a position indicative of a particular state, e.g., fully open or closed. The motor 116 may also be used to lock or unlock (e.g., alternatively or in addition to locking mechanism 146) the pet door 102 in embodiments where the pet door 102 may be locked. A linear actuator 160 (see FIG. 16) may similarly be used to move, lock, or unlock the pet door 102, described in more detail below.

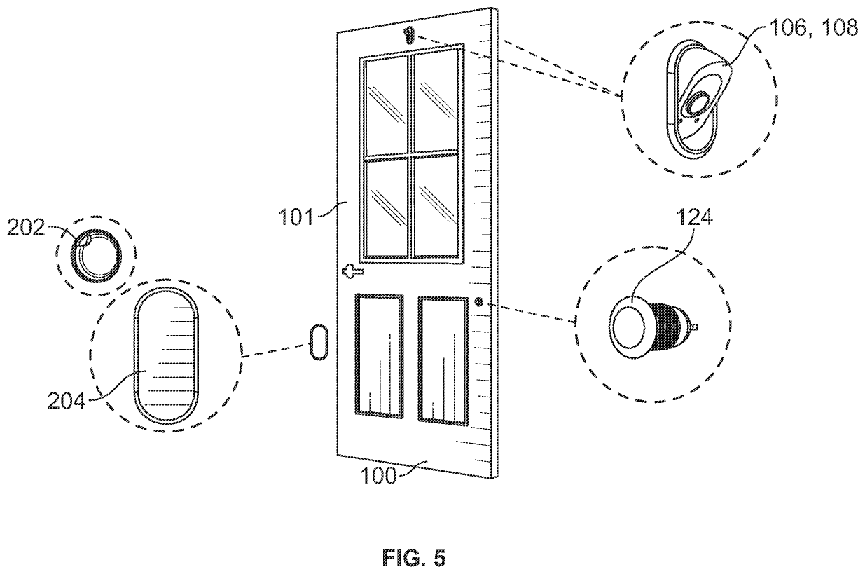

The interior camera 106 and exterior camera 108 may be mounted to interior (e.g., inside the home) and exterior (e.g., outside the home) surfaces of the door 100. Alternatively, the cameras 106, 108 may be substantially internal to the door 100 with lenses of the cameras being coplanar with or extending from the door surfaces. As shown in FIG. 5, the cameras 106, 108 may be mounted near an upper portion of the door 100 and angled downward. The cameras 106, 108 may also be mounted near vertically intermediate portion of the door 100. The cameras 106, 108 may be positioned so that images captured by the cameras 106, 108 include pets, persons and objects in front of the door 100. The door 100 may further include a third camera or additional cameras positioned on the exterior of the door 100 that are positioned to capture images having a wider field of view. These additional cameras may be used in conjunction with the exterior camera 108 to capture images of the exterior for a determination of whether certain security issues and/or weather conditions exist.

In one embodiment, the interior camera 106 may capture images of the interior of the home when the controller 104 determines that the pet is near the door 100, e.g., via communication with the pet collar device 200. In another embodiment, the interior camera 106 is continuously capturing images, for example, video. The images may be processed by the controller 104 or sent for processing at the remote computer 400. The images may be processed to determine if the image includes a known pet in front of the door 100. The processing may include machine learning-based image recognition, such as a convolutional neural network. For example, if a dog is sitting in front of the door 100 for a period of time, the controller 104 may determine to open the pet door 102 without homeowner intervention to allow the dog to enter or exit the home. As another example, once it has been determined that the dog wants to enter/exit and is attempting to operate the pet door, a message or notification is sent to user device 300, such as the smartphone of the homeowner. The message or notification may include one or more images recorded by the camera 106 as well as a prompt or query regarding whether the homeowner wishes to open the pet door 102. The homeowner may select to open the pet door 102 on the user device 100, e.g., via a smartphone application. The user device 300 may then send a control signal to open the pet door 102, e.g., via the internet. The images captured by cameras 106, 108 may continue to be processed to determine that the pet has successfully passed through pet door 102 and is not blocking the path of the pet door 102.

In another embodiment, when it is determined that the pet attempts to operate the pet door 102 and desires to exit the home, pictures or video captured by both the interior and exterior cameras 106, 108 are sent to the user device 300. As one example, a live video stream is transmitted to the user device 300. A user may view the video stream recorded by both the interior and exterior cameras 106, 108 to determine that the pet desires to exit the home and that there is nothing outside the home that may pose a hazard or threat to the pet or may enter the home if the pet door 102 is opened. As an example, if the video stream recorded by the exterior camera 108 shows or includes a predator (e.g., coyote or hawk) outside, the user may decide not to open the pet door 102 to let their pet out. As another example, the user may see that it is raining or muddy outside and may decide whether or not to let their pet out. When a pet is outside and it has been determined that the pet would like to enter the home, the user may view the image(s) captured by the exterior camera 108 to determine that only their pet will enter through the pet door 102. For example, if the image captured by the exterior camera 108 contains an image of the pet owner's dog and a stray cat, the user may decide to wait to let their dog back in until the stray cat has left the area and is out of view of the exterior camera 108. In situations where a user has multiple pets, the user may view the images recorded by the interior camera 106 to determine which pet is in front of the door 100 and desiring to exit. The user may then make a determination of whether to open the door 100 based on which pet is in front of the door 100.

The controller 104 and/or remote computer 400 may also be configured to open the pet door 102 based on the image data captured by the cameras 106, 108 and/or the presence of the pet collar device 200 detected by the communication circuitry 114 of the door 100. The controller 104 may be programmed to process the images recorded by the interior camera 106 and exterior camera 108. The controller 104 may use image processing techniques to identify whether a pet is in front of the door 100 and desires or is attempting to pass through the pet door 102. As one example, the controller 104 may be configured to compute a histogram of oriented gradients of one or more images captured by the cameras 106, 108 to determine whether the image includes features indicating that pets would like to pass through the pet door 102.

The controller 104 may be programmed to let the pet out without messaging or notifying the user device 300 when certain conditions are present. If the controller 104 determines those conditions are present in the images recorded by cameras 106, 108, then the controller 104 may open the pet door 102. The controller 104 may likewise be programmed to not let the pet out or to message or notify the user device 300 when certain conditions are detected. For example, if the pet is determined to be in proximity to the pet door 102 (e.g., via the proximity of the pet tag 200 and/or image data of the cameras 106, 108), the controller 104 may determine whether the pet is attempting to operate the pet door 102 based on the image data of the cameras 106, 108. The controller 104 may determine whether to open the pet door 102 based on the presence or absence of one or more conditions of either side of the pet door 102. For example, the controller 104 may determine not to open the pet door 102 if a particular condition is present on the side of the pet door 102 opposite the pet (e.g., undesirable conditions such as a predator, an unauthorized or unknown animal, precipitation, a wet yard, a muddy yard, gate left open, invisible fence system is down). Similarly, the controller 104 may determine not to open the pet door 102 if a particular condition is present on the same side of the pet door 102 as the pet (e.g., an unauthorized or unknown pet is detected). If there are no conditions present preventing the pet door 102 from being opened, the controller 104 may determine to open the pet door 102. If a condition preventing the pet door 102 from opening is present, the pet's attempt to operate the pet door may be disregarded.

The controller 104 may receive other data indicative of whether to open the pet door 102. As one example, the controller 104 may be configured to first identify the pet via the pet tag 200 and/or by processing the image data captured by the cameras 106, 108. As another example, the user may set a schedule for when the pet door 102 may be opened by the pets. The user may set such a schedule for each individual pet, thus requiring an identification of all pets proximate the pet door 102 before opening. The controller 104 may also be configured to open the door only when certain weather conditions are present. For example, if the controller 104 determines it is raining outside, such as by receiving weather data from a weather service via the network 402 or determined via the image data of the exterior camera 108. In some embodiments, when a condition is determined to be present, the controller 104 may cause a message or notification to be sent to the user device 300 prompting the user to decide whether or not to open the pet door 102.

The controller 104 may also communicate with other home control devices to determine whether to open the pet door 102. As one example, the controller 104 may receive a communication indicating an invisible fence is not functioning or a gate to the backyard was left open. Based on these potential security issues, controller 104 may determine not to let any pets out. Where a gate is within the field of view of the exterior camera 108, the controller 104 may process the images captured by the exterior camera 108 to determine whether the gate is open or closed or open. If the gate is determined to be open, the controller 104 may determine to disregard attempts by the pet to access the pet door 102 and exit the home. As another example, the pet access apparatus 10 may receive communication indicating whether another door of the home is open. As one example where the pet access apparatus 10 is the backdoor of a home leading to the backyard, the pet access apparatus 10 may receive updates on the status of the front door of the home. If the front door is determined to have been left open (e.g., it remains open for more than a predetermined length of time), the pet access apparatus 10 may determine to not let the pets into the home and to keep the pets within the backyard to prevent the pets from escaping the home through the front door. Where the pets are within the home and the front door is determined to have been left open, the pet door apparatus 10 may alert the owner and/or may open the pet door 102 and call the pets to exit the home through the pet door 102 via a spoken command played via the speaker 125.

Additionally and/or alternatively, the images captured by the cameras 106, 108 may be sent to remote computer 400 for image processing. The remote computer 400 may be programmed to apply image processing techniques to the images to determine whether conditions are present such that the pet door 102 should or should not be opened. If the proper conditions are determined to be present, the remote computer 400 may send a command to the door 100 via the network 402 to open the pet door 102. The remote computer 400 may use a deep neural network to process the images and determine the conditions present within the recorded images. The remote computer 400 may be configured to determine to whether to open the pet door 102 upon determining the pet is attempting to operate the pet door 102 similar to the controller 104 as described above.

The images captured by cameras 106, 108 may also be processed to identify which pet is within the captured image. One or more images of known pets may be stored in the memory 112 of the pet access apparatus 10 or in the remote computer 400 to facilitate pet identification and recognition. The processing may take place at controller 104 or at the remote computer 400. As one example, pet recognition may be based on one or more aspects including facial features, iris and retinal features, body shape, color, and markings/patterns, and/or other identifying characteristic to identify the pet within the image. Pet identification and recognition may also be based data collected via the microphone 123, sensor 180, the communication circuity 114 and/or other sensors including optical, capacitive, odor, etc. For example, pet identification and recognition may be based on communication with the pet collar device 200, bark pitch and/or timbre, odor, mood or temperament, movement, gait, paw print shape and/or size, fingerprint, nose print, etc. Examples of a smell sensor to detect odor include an artificial olfactory system and an electronic nose.

In some forms, the speaker 125 may be used to output a “spoken” command a known pet is known to respond to and the pet's behavior monitored to determine whether the pet responds to the command via the captured image data. For example, the command “sit” may be output via the speaker 125 and the pet's actions monitored via the image data to determine if the pet sits in response. Use of spoken commands to authenticate the pet as a known or authorized pet may be used as an alternative to or in addition to other methods of authentication. For instance, when the pet is muddy or recently received a haircut, the pet access apparatus may not be able to identify the pet with a requisite degree of confidence using only image processing techniques. Use of an additional method of authentication may then be performed to increase the confidence in the identification of the pet. The pet access apparatus 10 may use information regarding which pet is within the captured image to notify the owner that a certain pet desires to go outside or to keep a log of the pets passing through the pet door 102.

The images captured by cameras 106, 108 may further be used to monitor the movement and actions of each pet. For example, if it is determined that the pet is pacing in front of the door 100 across a series of image frames, it may be determined that the pet desires to pass through the pet door 102. The gait of the pet may also be used to identify the pet within the images. As another example, the posture of the pet may be identified. If the pet is sitting and facing the door 100, this may be determined to indicate that the pet desires to pass through the pet door 102. The pet door 102 may then be opened or a request may be sent to the owner indicating the pet desires to pass through the pet door 102.

The motion of the pets may be tracked over time to identify schedules of the pets, the pet's temperament, when something is wrong with the pet (e.g., the pet is limping), etc. The images from the cameras 106, 108 and other sensor input data (e.g., microphone 123) may further be processed to learn actions or behavior of the pet indicating the pet desires to pass through the pet door. For example, it may be determined that a particular pet paces in proximity to the pet door 102 when the pet needs to urinate or defecate. As another example, the pet may bark or whine while facing the door. When the images (and other sensor input) detect an action or behavior known to be associated with the pet desiring to pass through the door, pet access apparatus 10 may determine to open the pet door 102. The owner may also be notified when the actions or behavior of the pet is abnormal.

In embodiments where the pet access apparatus 10 is configured to open the pet door 102 without human intervention (e.g., without receiving a command via the user interface 122 or user device 300 to open the pet door 102), the pet access apparatus 10 may be configured to open the pet door 102 based on an identification of a pet. The pet access apparatus 10 may identify a pet using one or more identification and recognition methods described above. The pet access apparatus 10 may be configured to identify the pets based on multiple factors, for example, using two or more identification or recognition methods. If the pet is identified or recognized to be a specific pet by multiple identification methods, the pet access apparatus 10 may determine that the pet has been successfully identified and determine whether to grant the pet access based on the identification of the pet. Upon identifying the pet, the controller 104 may determine whether the pet is authorized to pass through the pet door 102. As an example, the pet access apparatus 10 may be programmed to only open the pet door 102 autonomously during certain times (e.g., 8 AM-5 PM). A pet owner may set a different schedule for each of their pets. The pet access apparatus 10 may identify the pet and determine if the pet desiring to pass through the door is allowed to do so based on a schedule, for example, a schedule set by the pet owner. The pet owner may also limit the number of times a particular pet is permitted to pass through the pet door 102 in a predetermined period of time.

The pet access apparatus 10 may further be configured to open the pet door 102 to various open positions based on the detected or identified pet. Where the pet door 102 is moved between closed and open positions, the pet door 102 may be moved to the fully open position creating the largest opening in the door 100 or to an open position intermediate the close position and the fully open position. The pet access apparatus 10 may determine the size of a specific pet via one or more images captured by the cameras 106, 108. The pet access apparatus 10 may determine an open position large enough to permit a specific pet to pass through. This minimizes the amount of heat entering or exiting the home when the pet door 102 is opened. Additionally, the pet access apparatus 10 may be configured to allow smaller pets to pass through and restrict larger pets or animals from pass through the pet door 102. For example, the pet owner may set a schedule permitting a small dog to pass through the pet door 102 but restricting a large dog from passing through the pet door 102 at a particular time. When the images from the cameras 106, 108 indicate the small dog and the large dog are both proximate the door (on the same side or opposite sides), then the pet access apparatus 10 may open the pet door 102 to a position large enough to permit the small dog to pass through, but inhibiting the large dog from passing through. As another example, when a smaller pet is detected to be outside with a predator or larger unknown animal (e.g., a stray dog), the pet door 102 may be opened to a size to permit the pet to pass through but preventing the predator or unknown animal from passing through the pet door 102.

Regarding FIG. 4, the pet access apparatus 10 may include a user interface 122. The user interface 122 may be in communication with the controller 104. The user interface 122 may be configured to receive input or commands from a user to control state of the pet door 102. For example, if a user is present, the user may control the state of the pet door 102 via the user interface 122. The user interface may include a switch or button 124, touchscreen display, microphone 123, and/or speaker 125 as examples. As an example, the user may press button 124 to cause the pet door 102 to open. The user interface 122 may also be used to program the pet access apparatus 10, setup the communication between the pet access apparatus 10 and the pet collar device 200, reset the pet access apparatus 10, and/or turn the door on or off as examples. The user interface 122 may include a speaker 125 that may be used to communicate commands with a pet when the pet owner is not present. The pet access apparatus 10 may include recorded sounds (e.g. stored in the memory 112) that the pet access apparatus 10 plays through the speaker 125. As one example, the pet access apparatus 10 plays an audio recording of the pet owner calling the pet to go outside or to come inside. As another example, the pet access apparatus 10 may play a jingle or a chime to indicate to the pet needs to go outside, go inside, eat, etc. A pet owner may communicate with pets via the speaker 125 of the user interface 122 over the network 402 using their user device 300. As an example, a user may initiate and conduct a voice call or video call with the pet access apparatus 10 over network 402 via their user device 300 and communicate with their pets via a speaker 125 and/or display screen of the user interface 122 of the pet access apparatus 10. The user interface 122 may include touchpad that the pet may touch to open the pet access apparatus 10 and/or to identify the pet. For example, the touchpad may be configured to detect the pets paw size, shape, fingerprint, and/or nose print. The touchpad may be a mat that the pet touches or walks on when in front of the door 100. The mat may be configured to weigh the pet which may be used to identify the pet.

Regarding FIG. 4, the door 100 may also include a handle. The handle may be used to open door 100, for example, by moving a latch of the door 100. The door 100 may include a handle on both sides of the door 100 configured to move the latch of the door 100 to allow door 100 to open. The handle may be a doorknob as an example. The door 100 may include a lock that prevents at least the handle on the exterior side of the door 100 from opening door 100. The door 100 may also include a lock, which may include a deadbolt. The lock may include a smart lock that permits a user to lock and unlock the door 100 remotely, for example, via a user device 300. The smart lock may be controlled via an application of the user device 300, such as application 302. Controller 104 may be configured to control the smart lock.

In yet another example, pets may be trained to interface with the door 100 to cause the pet door 102 to open. The user interface 122 may include a vibration sensor or touch sensor that detects when a pet taps or touches the door or floor near the door, requesting the pet door 102 be opened. In another example, a pet may be configured make noise in proximity to the door to cause the pet door 102 to open. For example, a dog may be trained to bark toward the door to request that the door open. As another example, the dog may be trained to ring a bell, buzzer or the like to indicate a desire to pass through the pet door 102. The pet access apparatus 10 may include a microphone 123 that picks up the sound made by the dog. The pet access apparatus 10 may process the signal and may open the pet door 102. The pet access apparatus 10 may be configured to identify the pet and determine whether the pet is authorized to pass through the pet door 102.

Regarding FIG. 6, the pet access apparatus 10 may include a locking mechanism 146 that locks the pet door 102. As an example, when the pet door 102 is in a closed state, the locking mechanism 146 may be engaged to prevent the pet door 102 from being forced to an open position. The locking mechanism 146 may be in communication with the controller 104. The controller 104 may send a control signal to the locking mechanism 146 to lock the pet door 102. The controller 104 may be programmed to lock the pet door 102 whenever the pet door 102 is closed. The locking mechanism 146 may be or include a solenoid or linear actuator that moves the pin or rod in a manner similar to how a bolt is moved by a deadbolt lock. The locking mechanism 146 may include a pin or rod that, when in a locked position, extends into a portion of the pet door 102 preventing the pet door 102 from moving. The locking mechanism 146 may unlock the door by withdrawing the pin or rod from the pet door 102, thereby allowing the pet door 102 to be moved. The locking mechanism 146 may alternatively or additionally include a latch that engages a portion of the pet door 102 to prevent lateral movement of the pet door 102.

Regarding FIG. 4, the pet access apparatus 10 may include a sensor 180 that is in communication with controller 104. The sensor 180 may include a motion sensor configured to detect whether an object, such as a pet, passes through the pet door 102. The motion sensor may be mounted on a surface of door 100 near the pet door 102. Alternatively or additionally, the sensor 180 may include an obstruction detector configured to detect when an object is in the path of the pet door 102 that prevent the pet door 102 from closing. For example, the obstruction detector may detect whether the pet has stopped part way through the pet door 102 and prevent the pet door 102 from closing until the pet is no longer in the path of the pet door 102. The sensor 180 may include, for example, a contact edge sensor, an infrared light beam or light curtain, and/or a capacitance sensor. The pet access apparatus 10 may use the sensor 180 to determine whether the pet has passed through the pet door 102 after opening the pet door 102. Upon determining that the pet has passed through the pet door 102, the pet access apparatus 10 may close the pet door 102. The pet access apparatus 10 may be configured to close the pet door 102 rapidly after determining the pet has passed through the pet door 102 to prevent other animals from passing through the pet door 102 while the pet door 102 remains open.

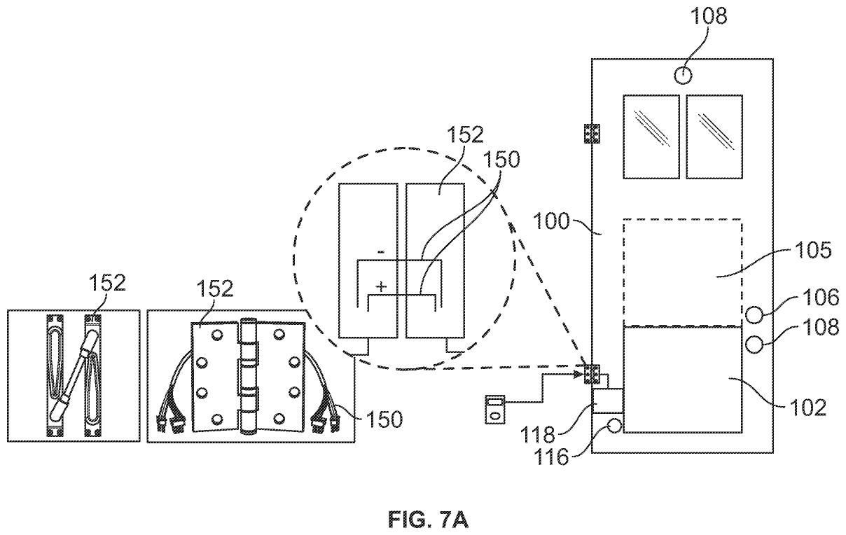

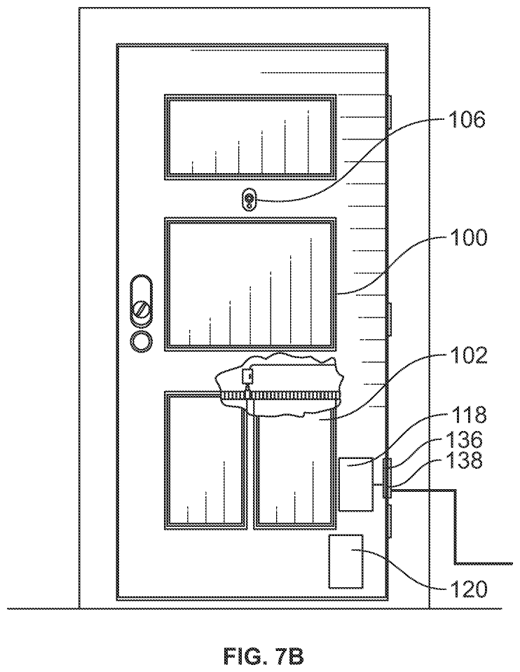

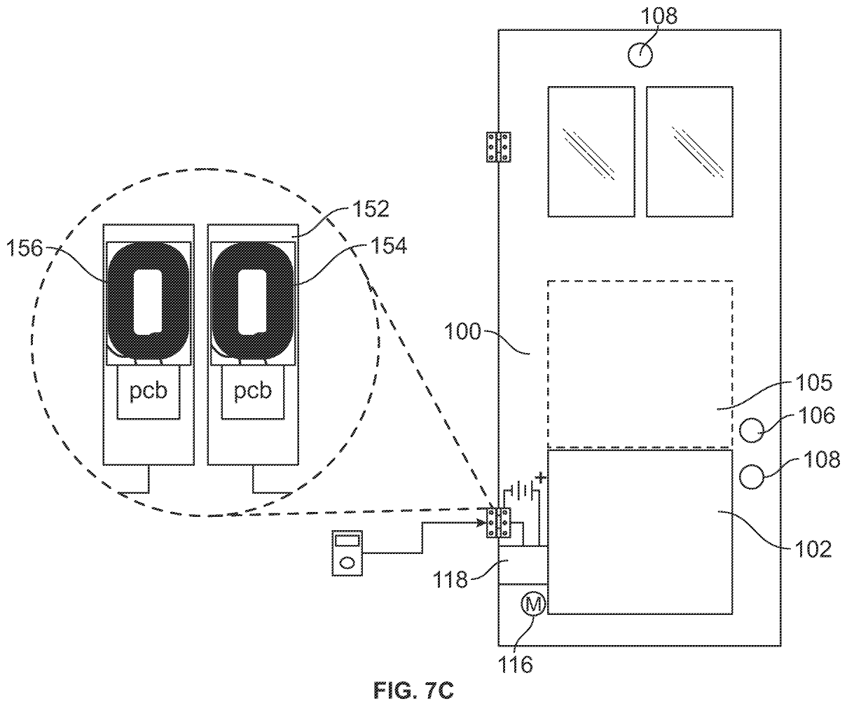

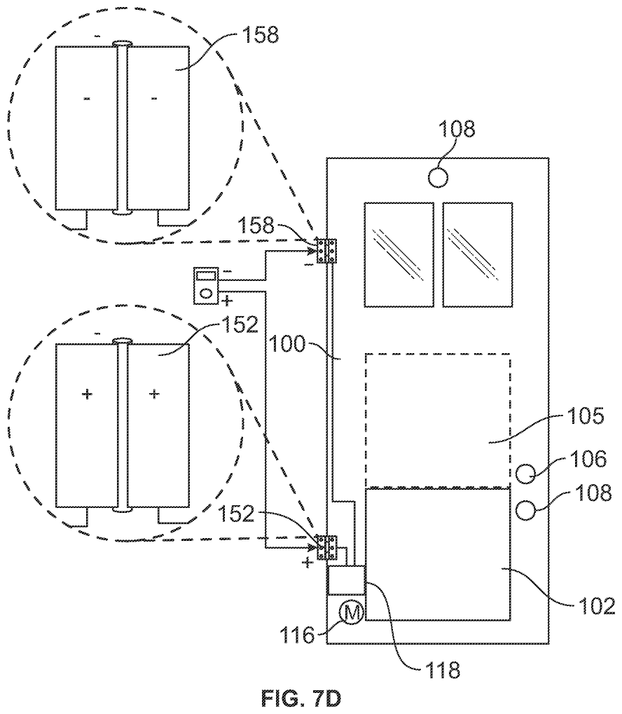

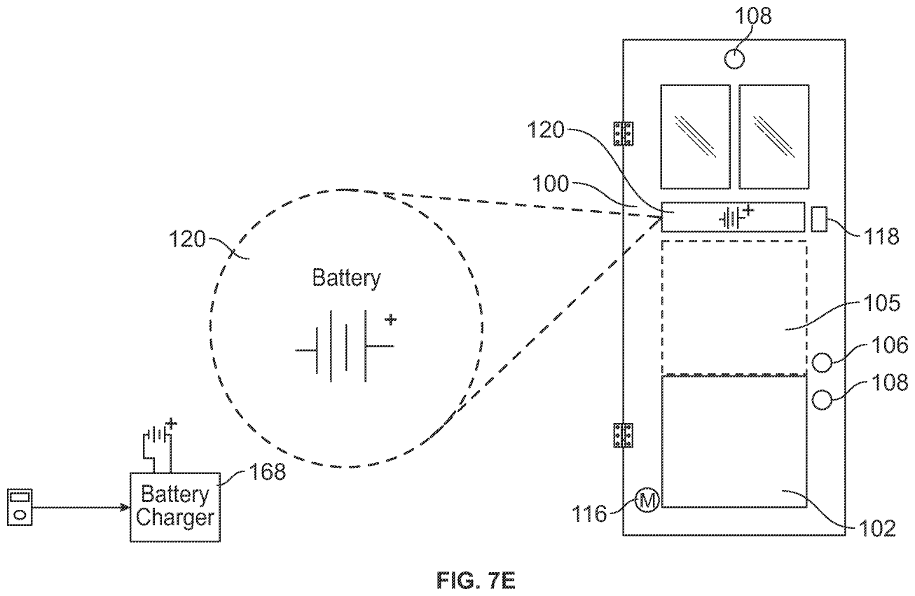

The door 100 and the components of the door 100 may receive their power via a power input 118. The power input 118 may be a terminal that receives power from a power source external to the door 100. In one embodiment shown in FIG. 7A, the power input 118 is connected to flexible wiring 150 that traverses a gap between a doorframe and the door 100 for example proximate to one or more hinges 152. The flexible wiring 150 may include a plug that may be plugged into to a conventional power outlet, be wired directly to the mains power supply of the home, or other power supply device. Although not shown, a battery 120 may optionally be connected to the power input 118 for charging and to operate the door 100 during a power outage and/or when the door is open.

In another embodiment, such as that shown in FIG. 7B, the power input 118 includes one or more conductive contacts 136. The contacts 136 may be brought into contact with complementary contacts 138 external to the door, e.g., in the door frame, door hinge, or floor. The external contacts 138 may receive power via an electrical outlet or the home mains power. The contacts 136 of the door 100 may be brought into contact with the external contacts 138 when the door 100 is closed to provide electrical power through the contacts 136 to the power input 118. In one example, the contacts 136 of the door 100 are included on the edge of the door 100 that the hinges attach to. The external contacts 138 may be in the door frame. Thus, when the door 100 is closed, electrical power may flow through the contacts 136, 138 and to the power input 118 within the door 100. The door 100 may include a battery 120 that is charged when the door 100 is closed and the power input 118 receives electrical power from the home. The door 100 may then continue to communicate and operate via electrical power from battery 120 even when the door 100 is open.

In yet another embodiment, such as that shown in FIG. 7C, the power input 118 is connected to a coil 154 within the door 100, such that when the door 100 is closed, the coil 154 is positioned proximal to a coil 156 external to the door 100, for example, in the hinge 152, door frame, threshold or floor. The coil 154 of the power input 118 may function as the secondary coil of an inductive, wireless power transfer system. As shown in FIG. 7C, the coil 154 is positioned along the edge of the door 100 attached to the door frame by hinges. A primary coil 156 is positioned within the door frame near hinge 152. The primary coil 156 is proximal to the secondary coil 154 of the door 100 when the door 100 is closed. As electrical current passes through the primary coil 156, current flow is induced in the secondary coil 152 of the door 100. Electrical power may thereby be wirelessly transferred to the power input 118 of the door 100. The power input 118 may be connected to and charge a battery 120 so that the door 100 remains powered even when the door 100 is opened and the secondary coil 154 is moved away from the primary coil 156 of the power induction system.

In another embodiment, such as that shown in FIG. 7D, direct current power is supplied to the door through hinges 152, 158. An AC-DC power supply may be connected to the home's mains power supply. The positive output terminal of the AC-DC power supply may be connected to the portion of hinge 152 attached to and electrically isolated from the door frame. The negative output terminal of the AC-DC power supply may be connected to the portion of hinge 158 attached to and electrically isolated from the door frame. A first wire may connect the positive terminal of power input 118 to hinge 152 attached to the door 100. A second wire may connect the negative terminal of power input 118 to hinge 158 attached to the door 100. Thus, the power input 118 may be in electrical communication with the AC-DC power supply via the hinges 152, 158 to provide power to the door 100. The door 100 may include a battery 120 that is charged via the power input 118. In a similar but alternate configuration, AC power may be supplied to the door through one or both hinges 152, 158 which may include a slip ring-type mechanism.

In another embodiment, such as that shown in FIG. 7E, the door 100 includes a battery 120 that is replaceable and/or rechargeable. In this embodiment, the battery 120 may be removable from and replaceable to the door 100 via a battery access door that may be opened and closed by the homeowner. The battery 120 may be transported to a battery charger 168 for charging. The battery 120 may be inserted into a portion of the door 100 to provide the door with electrical power. The door 100 may also include a charging port, that may receive a charging cable connected to a battery charger or a wall outlet to charge the battery 120. The door 100 may also include a battery charger 168 within the door 100 to charge battery 120 with electricity provided via the charging cable.

The pet door 102 may form a portion of door 100, for example, a lower portion of the door 100. A variety of embodiments of the pet door 102 are disclosed below. The pet door 102 or a portion thereof may be slidingly connected to a body 101 of the door 100. The body 101 supports the pet door 102 and associated components and is connected to the door frame via hinges. The door 100 may include a window 107 that is transparent or translucent. In some of the embodiments, the pet door 102 may slide on tracks or rails 142 and be moved into open or closed positions by a motor 116 or linear actuator 160. In embodiments where the pet door 102 may be locked, the motor 116 or linear actuator 160 may alternatively or additionally be used to lock or unlock the pet door 102. Indeed where a linear actuator 160 is shown or described, a motor 116 may also be used and vice versa. Additionally, where two motors 116 or linear actuators 160 are shown, a single motor 116 or linear actuator 160 may be used along with a coupling or linkage system.

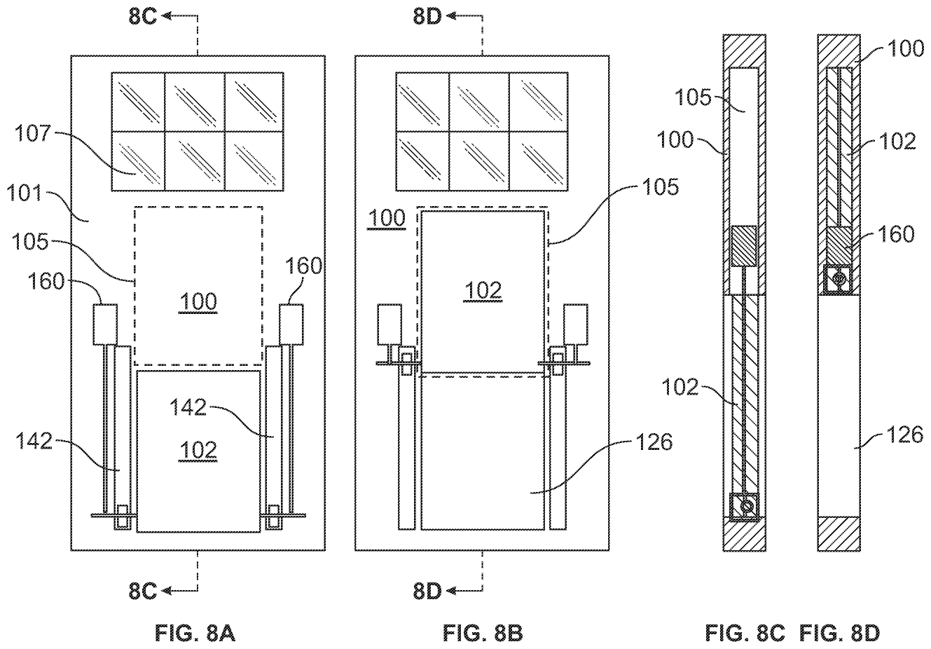

In the embodiment of FIGS. 8A-D, the pet door 102 moves vertically. As shown in FIGS. 8A and 8C, the pet door 102 is in a closed position, with the pet door 102 lowered to the bottom of the door 100. In the closed position, the pet door 102 covers an opening 126 in the body 101 of the door 100. As shown in FIGS. 8B and 8D, the pet door 102 is an open position, with the pet door 102 drawn upward from the closed position. The body 101 of the door 100 may include a pocket 105 that the pet door slides into as the pet door 102 opens.

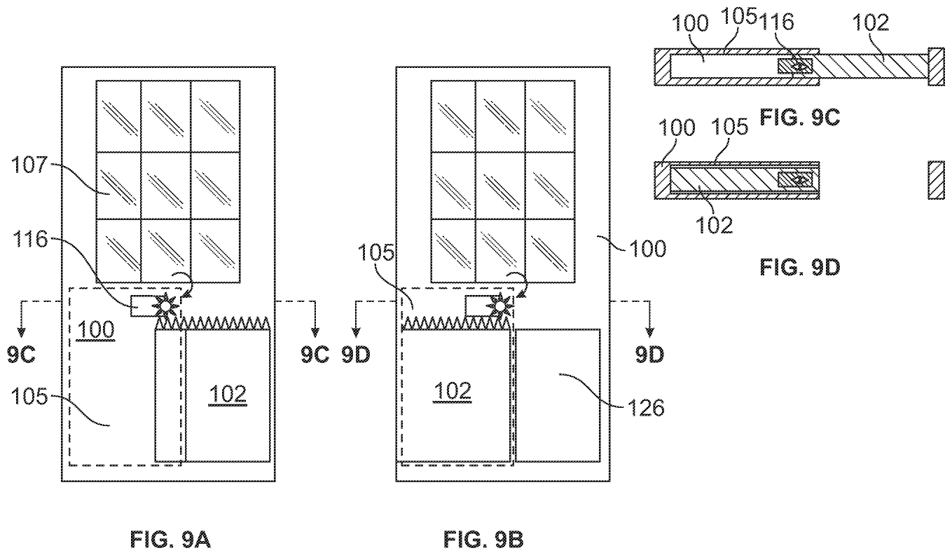

In the embodiment shown in FIGS. 9A-D, the pet door 102 moves horizontally. As shown in FIGS. 9A and 9C, the pet door 102 is in a closed position, with the pet door 102 extended to the right and covering the opening 126. As shown in FIGS. 9B and 9D, the pet door 102 is an open position, with the pet door 102 drawn horizontally to the left. In the open position, the pet door 102 or a portion thereof is in within a pocket 105 of the door 100.

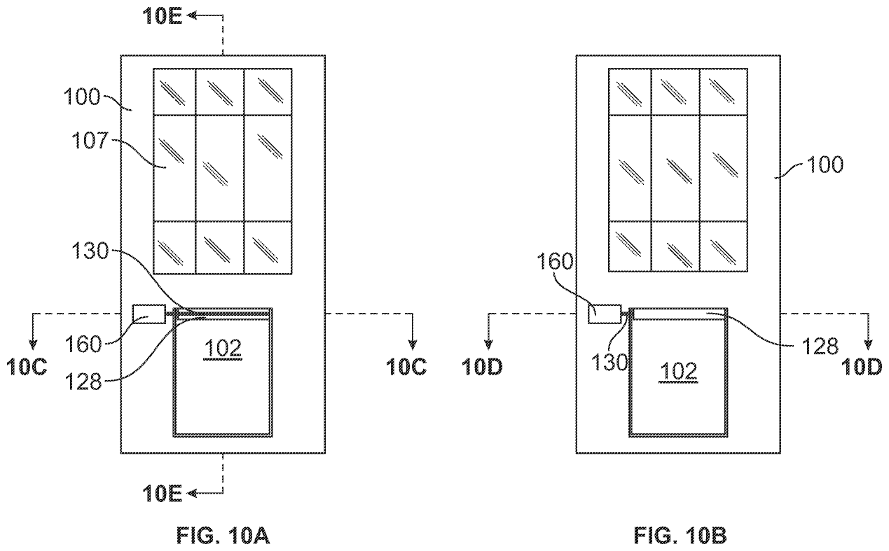

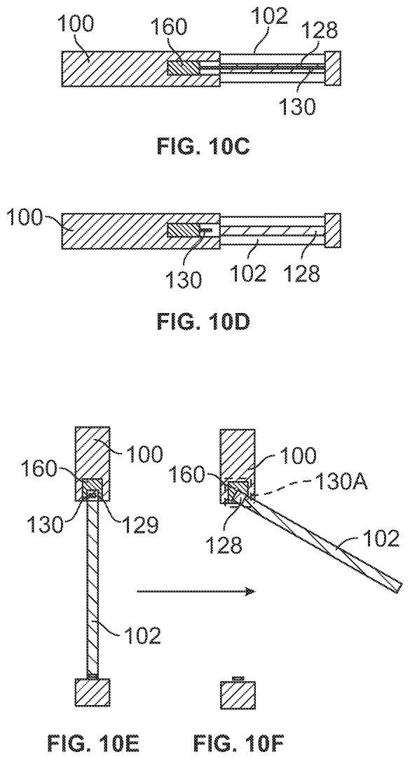

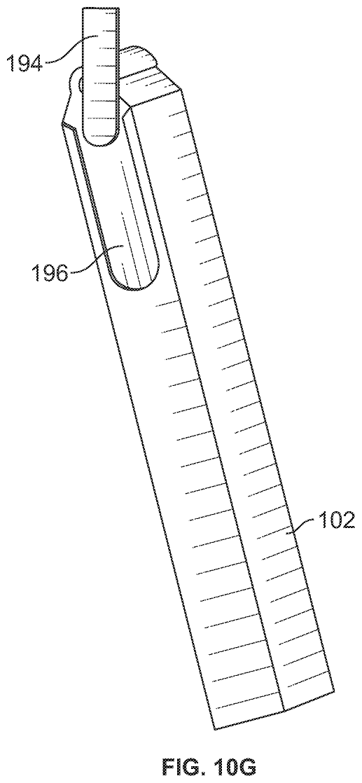

In the embodiment shown in FIGS. 10A-F, the pet door 102 may be a flap that is pivotally attached to the body 101 of the door 100 near a top of the opening 126 via a hinge 128. The pet door 102 is pivotal about a horizontal axis. In other embodiments, the pet door 102 may be pivotally attached by a hinge to the sides of the opening 126, with the pet door 102 pivotal about a vertical axis. The pet door 102 would pivot horizontally which may reduce the power required to open and close the pet door 102 because the door opening would not be a lifting operation.

In the embodiment of FIG. 10A, the pet door 102 is normally in the closed position, with the pet door 102 covering the opening 126 of the door 100. The pet door 102 may be opened by rotating a shaft of the motor 160 to pivot the hinge 128 and arcuately swing the pet door 102 (e.g., a lower portion) inward or outward about the hinge 128. The pet door 102 of this embodiment includes locked and unlocked states. As shown in FIGS. 10A, 10C, and 10E, the pet door 102 is in a closed position in the locked state. In the locked state, a rod 130 extends through a through opening 129 of the pet door 102 to prevent the pet door 102 from rotating about the hinge 128. The rod 130 and opening 129 may have a non-circular cross-sectional shape to prevent the pet door 102 from rotating when the rod 130 extends in the opening 129. In another embodiment, the opening 129 may be at another portion of the door, such as the bottom portion of the pet door 102. In the locked state the rod 130 extends into opening 129 to prevent pet door 102 from rotating about the hinge 128. As shown in FIGS. 10B, 10D, and 10F, the pet door 102 is an unlocked state with the rod 130 withdrawn from the through opening 129 of the pet door 102 allowing pet door 102 to rotate about hinge 128. The rod 130 may be moved between locked and unlocked positioned by a solenoid or linear actuator 160.

In the embodiment shown in FIGS. 10A-F, a torsion spring 130A may be used in conjunction with hinge 128. The torsion spring 130A may bias the pet door 102 to a position, for example, an open position or a closed position. In the example where the torsion spring 130A biases the pet door 102 to an open position, the torsion spring 130A applies a force on the pet door 102 to urge the pet door 102 toward the open position. The pet door 102 may include a damper that controls the speed of the opening of the pet door 102 by the spring. To close the pet door 102 from the open position, a motor 116 may be used to rotate the pet door 102 about the hinge 128 against the bias of the torsion spring 130A until the opening 126 in the door 100 is closed. The motor 116 may include a worm drive motor system where the hinge shaft of the pet door 102 includes a worm gear that engages a worm driven by the motor 116. The self-locking nature of the worm drive may enhance or replace the rod 130 and opening 129 locking mechanism described above. Alternatively, as shown in FIG. 10G, a linear actuator 160 or solenoid may be used to extend a rod 194 into an opening or cam 196 in the pet door 102 to force the pet door 102 into a closed position. As the rod 194 is extended into the cam 196 of the pet door 102, the pet door 102 is brought into alignment with the rod 194, overcoming the biasing force of the spring to bring the pet door 102 to a closed position. The rod 194 may include a roller on the end to reduce the friction between the rod 194 and the pet door 102 as the rod 194 moves along the cam 196.

In an alternate configuration of this embodiment, the pet door 102 may have its hinge 128 proximate the bottom of opening 126 rather than proximate the top of opening 126 as shown. In this way, when the pet door 102 is moved to an open position (e.g. either opened inwardly to allow egress or opened outwardly to allow ingress) the pet door 102 provides an inclined ramp to facilitate ingress or egress of elderly pets or pets that have difficulties climbing over the portion of the door 100 between the floor and the bottom of the opening 126.

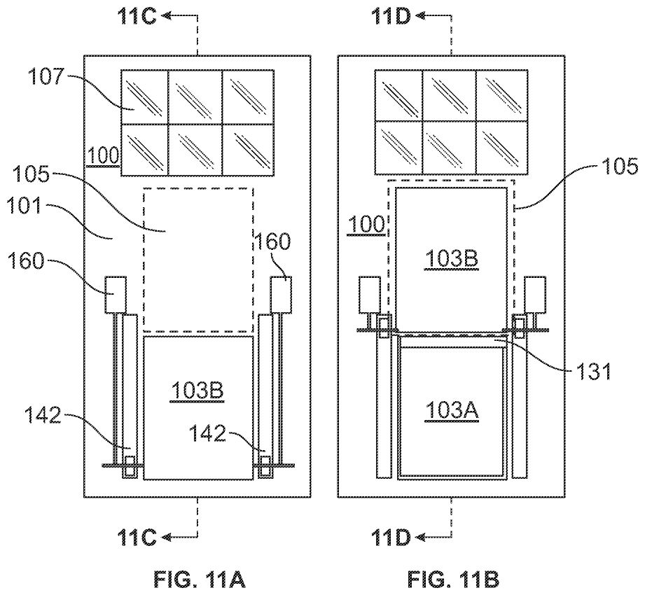

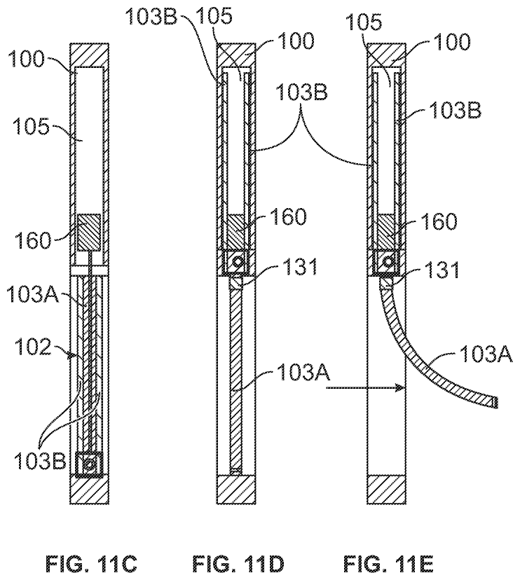

In the embodiment of FIGS. 11A-E, the pet door 102 includes a flap 103A as well as panels 103B that move vertically. In this embodiment, the pet door 102 is normally in a closed state position, with the flap 103A of the pet door 102 covering the opening 126 of the door 100. In the closed state, the pet door 102 may have a locked or an unlocked state. As shown in FIGS. 11A and 11C, the pet door 102 is in a locked state, with the panels 103B of the pet door 102 lowered to the bottom of the door 100 on either side of the flap 103A such that the flap 103A is sandwiched between two panels 103B as best shown in FIG. 11C. As shown in FIGS. 11B and 11D-E, the pet door 102 is an unlocked state, with the panels 103B of the pet door 102 drawn upward from the closed position. The panels 103B of the pet door 102 are held within a pocket 105 of the door 100. In the unlocked state, the flap 103A may swing or bend about a connection 131 when force is applied to the pet door 102 to open the flap 103A to allow a pet to pass through. In the locked state, the panels 103B prevent the flap 103A from swinging or bending about the connection 131.

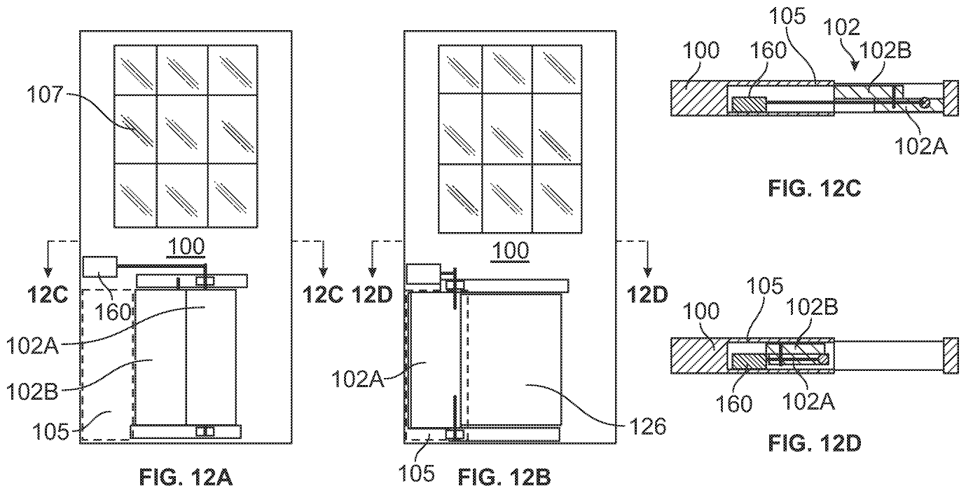

In the embodiment of FIGS. 12A-D, the pet door 102 is comprised of two panels 102A and 102B that slide relative to one another similar to a stackable partition. As shown in FIGS. 12A-D, the panels 102A,102B move horizontally, however, this two panel configuration may be adapted to move vertically. The pet door 102 is shown in a closed position in FIGS. 12A, C. In the closed position, the panels 102A, 102B of pet door 102 are extended to cover the opening 126 in door 100. In FIGS. 12B and 12D, the pet door is shown in an open position. In the open position, panels 102A, 102B are withdrawn into a pocket 105 of door 100. The panels 102A,102B may be coupled to one another such that when panel 102A moves to the open or closed position, panel 102A pulls 102B along with it. A motor 116 or linear actuator 160 may be coupled to panel 102A and cause panel 102A to move horizontally, which in turn also causes panel 102B to move.

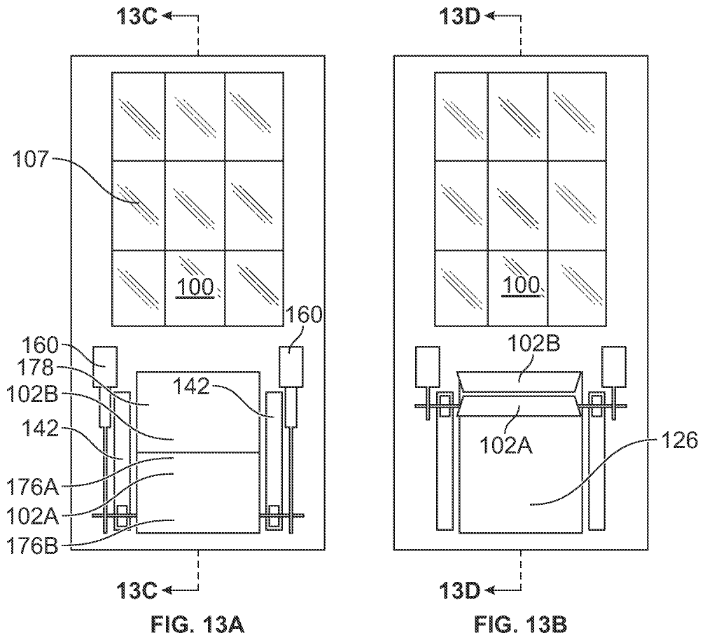

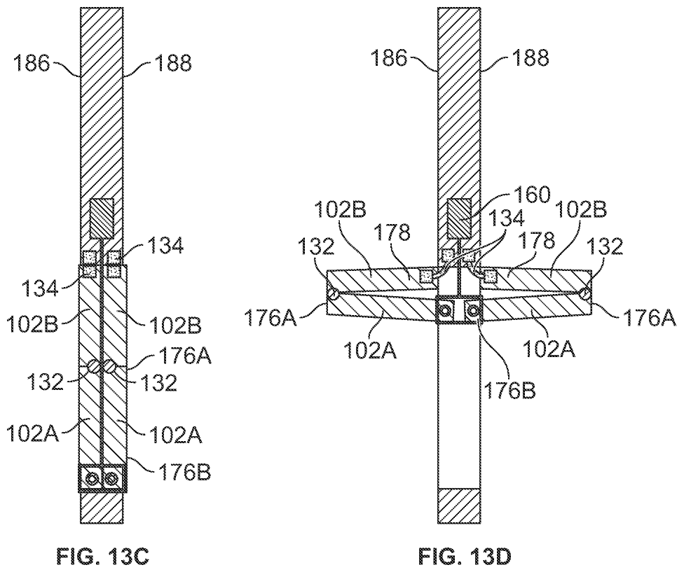

In the embodiment shown in FIGS. 13A-D, the pet door 102 is shown in a bifold configuration. The pet door 102 may include an interior side 186 and an exterior side 188 both including two panels 102A, 102B. An end 176A of panel 102A is connected at a hinge 132 to panel 102B. The end 178 of panel 102B opposite the hinge 132 may be attached to the door 100 by hinge 134. As shown in FIGS. 13A-D, the panels 102A, 102B are drawn upward, however, this two panel configuration may be adapted to draw the panels 102A, 102B horizontally towards a side of the opening 126. The pet door 102 is shown in a closed position in FIGS. 13A, C. In the closed position, the panels 102A, 102B of pet door 102 are lowered to cover opening 126. In FIGS. 13B and 13D, the pet door 102 is shown in an open position. In the moving from the closed to open position, the end 176B of panel 102A opposite the hinge 132 is drawn upward. As the end of panel 102A is drawn upward, panel 102A, 102B pivot relative to each other about hinge 132 and panel 102B pivots about hinge 134. As panel 102A is drawn upward, the opening 126 of door 100 is uncovered creating a passageway for a pet to pass through.

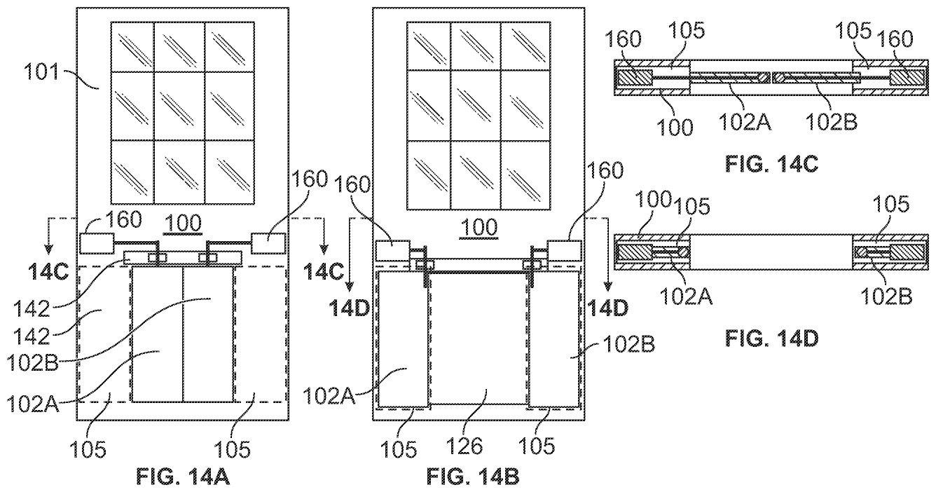

In the embodiment shown in FIGS. 14A-D, the pet door 102 includes two panels 102A, 102B. The panels 102A, 102B may be moved horizontally independently of each other, for example, by linear actuators 160 connected to each panel 102A, 102B. As shown in FIGS. 14A and 14C, the pet door 102 is in a closed position, covering opening 126 of the door 100. As shown in FIGS. 14B and 14D, the pet door 102 is in an open position. In moving from the close to open position, panel 102A is drawn to the left and into a pocket of the door 100 while panel 102B is drawn to the right into a pocket 105 of the door 100. In some instances, depending on the size (e.g. width or girth) of the pet, one of the two panels 102A, 102B may be moved to permit ingress and egress rather than both panels.

In yet another embodiment, the pet door 102 may be a roll-up door sized to cover the opening 126 when in the closed position. For example, the pet door 102 may be include a plurality of slats hingedly connected to another. The pet door 102 may be drawn upward and rolled about itself on an axis by a tubular motor when moving to the open position. The pet door 102 may be drawn into a pocket 105 of the door 100 when in the open position. In moving from the open position to the closed position, the pet door 102 may be unwound and lowered downward from the tubular motor to cover the opening 126 in the door 100. The pet door 102 may be guided by a track or rails as the pet door 102 is moved between open and closed positions. The door may be covered with a thin, flexible membrane or sheet of material to span the pet door 102 to aid in concealing the pet door 102 when in the closed position. For example, the membrane may have an appearance that mimics the material and finish of the door 100 or panels 109 of the door 100.

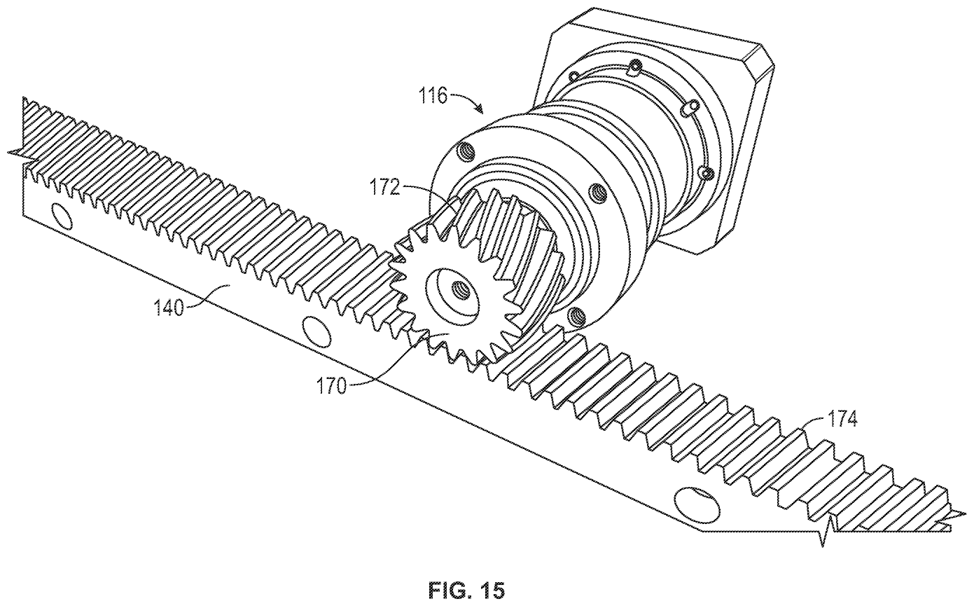

With respect to FIGS. 15-16, examples of the motor 116 and linear actuator 160 are shown. Motor 116 and/or linear actuator 160 may be used to move the pet door 102 between the open and closed positions. The motor 116 or linear actuator 160 may also be used to lock or unlock the pet door 102 in embodiments where the pet door 102 may be locked. The motor 116 may rotate a gear such as a pinion 170. The pinion 170 includes teeth 172 protruding from the center portion of the pinion 170. The pet door 102 may include a rack 140. For example, the rack 140 may be mounted to one or more edges 141 of a body 143 of the pet door 102 as shown in both FIGS. 6 and 17. The rack 140 includes teeth 174 disposed along the length or a portion thereof that are sized to engage the teeth 172 of pinion 170. The teeth 172 of pinion 170 are positioned to intermesh with the teeth 174 of the rack 140. When the motor 116 is operated, the gear 170 turns forcing the rack 140, along with the body 143 of the pet door 102, to move. In another embodiment, the motor 116 turns a wheel that rests on an edge of the pet door 102. The frictional force between the wheel and the pet door 102 may be sufficient such that when the wheel is rotated, the pet door 102 is moved. Alternatively, the motor 116 or other rotary actuator may turn a sprocket that drives a flexible coupling such as an endless belt or chain to move the pet door 102.

Regarding FIG. 16, a linear actuator 160 may also be used to move the pet door 102 between open and closed positions or to lock or unlock the pet door 102. The linear actuator 160 includes an arm 162 that the extends from the base 166 and includes an attachment portion 164. When operated, the arm 162 extends from or retracts toward the base 166 of the linear actuator 160. When the base 166 of the linear actuator 160 is secured to door 100, and the pet door 102 is attached to the attachment portion 164 of the linear actuator 160, the linear actuator 160 may move the pet door 102 towards or away from the base 166 when actuated. In some embodiments, more than one linear actuator 160 may be attached to the pet door 102 and used to change the position of the pet door 102. The linear actuator 160 may be electric, hydraulic, or pneumatic.

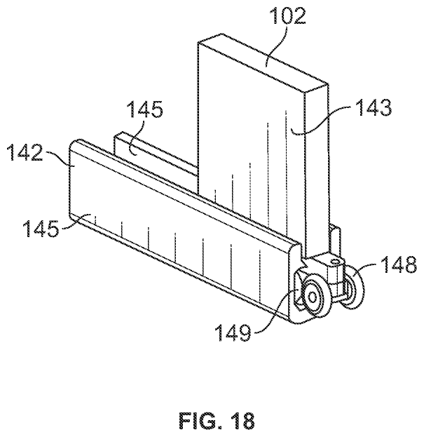

Regarding FIG. 18, the door 100 may include one or more tracks or rails 142 positioned along the path of the pet door 102 to guide the pet door 102 as the pet door 102 moves between open and closed configurations. The rails 142 may have a generally U-shaped or square U-shaped cross-section and be sized to receive an edge of the pet door 102 within the interior of the U-shaped portion. In the embodiment shown in FIG. 18, the pet door 102 includes rollers 148 to facilitate movement of the pet door 102 between closed and open positions. The rail 142 may include a pair of walls 145 with a channel 149 sized to receive rollers 148 and to keep the rollers 148 received in the rail 142.

The controller 104 of the door 100 may control or operate the motor 116 or the linear actuator 160. The controller 104 may control the direction that the motor 116 turns and/or the direction of movement of the attachment end 164 of the linear actuator. The controller 104 thus is able to control the position of the pet door 102 and change the state of the pet door 102 from open to closed and vice versa. The controller 104 may also cause the pet door 102 to move to an intermediate position, such as to provide a smaller opening for a smaller pet. The controller 104 may communicate with limit switches 144 (see FIG. 6) positioned along the path of the pet door 102. For example, a limit switch 144 may be positioned such that the edge of the pet door 102 contacts the limit switch 144 when the pet door reaches the fully opened position. Likewise, a limit switch 144 may be positioned such that the edge of the pet door 102 contacts the limit switch 144 when the pet door 102 reaches the fully closed position. The controller 104 may be in communication with the limit switches 144 and operate the motor 116 or linear actuator 160 until a signal is reached from the limit switch 144 indicating the pet door 102 has reached the fully open or closed position.

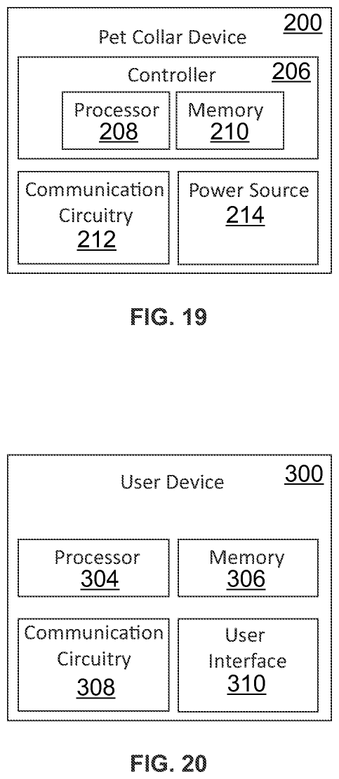

With reference to FIG. 19, the pet collar device 200 may include a controller 206 having a processor 208 and memory 210. The memory 210 may store programs and instructions for execution by the processor 208 to carry out the functionality of the pet collar device 200. The processor 208 may communicate with remote devices via the communication circuitry 212. The communication circuitry 212 may be configured to communicate over one or more wireless communication protocols including, for example, wireless fidelity (Wi-Fi), cellular, radio frequency (RF), infrared (IR), Bluetooth (BT), Bluetooth Low Energy (BLE), Zigbee, Z-wave and near field communication (NFC). The communication circuitry 212 may include an RFID tag 202 configured to transmit RF signals identifying the pet collar device 200. The pet collar device 200 may be contained in a housing that includes a clip or loop for attaching to a pet, for example, a collar of the pet. Alternatively, the pet collar device 200 may be a collar or harness that is secured to or worn by a pet. The pet collar device 200 may include a power source 214 to provide power to the controller 206 and communication circuitry 212. The power source 214 may be a battery, such as a coin-sized battery. The power source 214 may include a generator that generates electrical power from kinetic movement of the pet to recharge a battery of the pet collar device 200. Although not shown, the pet collar device 200 may optionally include one or more sensors such as a gyroscope, accelerometer, a positioning device (e.g. global positioning system (GPS) receiver), thermometer, heart rate monitor, etc. Such one or more sensors can provide outputs of data or information to facilitate determinations or decisions (e.g., open or close pet door 102) made by the processor 110 of the pet access apparatus 10 and/or the remote computer 400 in addition to or in lieu of images or video from cameras 106, 108.

The pet collar device 200 may communicate with the pet access apparatus 10. The pet collar device 200 may, for instance, communicate location information of the pet associated with the pet collar device 200 to the pet access apparatus 10. As one example, the pet collar device 200 communicates with the pet access apparatus 10 via Bluetooth or Bluetooth low energy (BLE). The pet access apparatus 10 may determine the proximity of the pet collar device 200 to the pet access apparatus 10 based on the strength of the Bluetooth signal received from the pet collar device 200. The pet access apparatus 10 may also be able to determine the angle of approach of the pet collar device 200 to determine whether the pet is heading toward the pet access apparatus 10 and not just walking or passing by it. For example, the pet access apparatus 10 may include two or more antennas (e.g., one interior and one exterior) that facilitate angle of arrival/approach calculations. Use of multiple antennas may aid the pet door apparatus 10 in determining whether the pet is inside or outside based on the position of the pet collar device 200.

In another example, the pet collar device 200 may receive signals from the pet access apparatus 10. The signals from the pet access apparatus 10 may be sent according to a schedule to indicate to the pet to approach the pet access apparatus 10 to exit outside to relieve itself and/or to exercise/play. The pet collar device 200 may include a vibration mechanism or speaker. When the pet collar device 200 receives a signal from the pet access apparatus 10, the pet collar device 200 may vibrate or play noise, music, or a voice recording over the speaker. The pet collar device 200 may also receive these signals via the network 402 from the user device 300 or remote computer 400. As one example, a pet owner may speak to their pet via a speaker of the pet collar device 200. As another example, the pet owner may select to send a signal (e.g., recorded message, chime, vibration) to the pet collar device 200 indicating to the pet to go outside.

The pet collar device 200 may track the motion of a pet. As an example, the pet collar device 200 may track the number of steps the pet takes or the distance the pet travels. Using one or more sensors, the pet collar device 200 may distinguish between different pet activities such as running, walking, jumping, rolling, etc. This information may be communicated to the pet access apparatus 10, the remote server 400, and/or user device 300. A user may view this recorded information or be prompted to take action based on the recorded information. For example, if a dog has not moved enough throughout the day, the pet owner may be notified via their user device 300 of the same, prompting the pet owner to take the dog outside or for a walk. As another example, if the pet does not move very much throughout the day, the pet owner may by notified that something may be wrong with their pet.

The motion data of the pet recorded by the pet collar device 200 may be processed by the pet access apparatus 10 and/or remote computer 400. An algorithm may be applied to the motion data to determine motion indicative of certain conditions, e.g., that the pet needs to urinate. The motion data may also indicate that a pet is eating or drinking. Identifying such activities may be further facilitated by a microphone of the pet collar device 200 for example to identify sounds of chewing food or lapping water. Identifying when these actions occur may allow the pet access apparatus 10 to determine approximately how long before the pet needs to go outside to urinate/defecate based on a comparison with historical motion data.

The pet collar device 200 may also be able to track the location of the pet over time. The pet collar device 200 may include a tracking device. The tracking device may use a global navigator satellite system, e.g., GPS, cellphone tower location data, and/or LoRa technology, e.g., LoRa 900 as some examples. The pet collar device 200 may record where the pet has traveled or communicate location information that is processed by a remote device, such as pet access apparatus 10 or remote computer 400. The location information may be used to locate a pet when the pet goes missing, for example. The location information may also track and monitor the distance the pet traveled during the day and whether the pet needs more exercise. The pet collar device 200 in conjunction with the pet access apparatus 10 and/or remote computer 400 may be able to determine when and where the pet defecates using collected motion data from the pet collar device 200, posture information (e.g., squatting as determined by analysis of still or moving images captured by exterior camera 108), etc. and record the location or locations of excretions. The pet owner may use the excretion location information (e.g., as relative or absolute coordinates, on a map displayed via the user interface 310 of the user device 300) for the purpose of cleaning up after the pet more quickly since excretions need not be searched but rather may be found using the pinpointed locations. Still further, such pinpoint excretion location information may be communicated from the pet access apparatus 10 or from the remote computer 400 to an autonomous terrestrial robot or aerial drone that may pick up and dispose of the excretions without human intervention. Alternatively, such pinpoint excretion location information may be communicated to a third-party excretion removal service that may subsequently offer its services to the homeowner and thereafter dispatch an excretion-removal associate to dispose of the excretions using the location information.

The user device 300 may include a number of different electronic devices, such as a smartphone, a wearable (e.g. smartwatch), personal computer, in-vehicle devices (e.g. infotainment, navigation and telematics systems), or tablet computer to name a few examples. With reference to FIG. 20, the user device 100 includes a processor 304 in communication with a non-transitory computer readable media such as a memory 306, communication circuitry 308, and a user interface 310.

The memory 306 may be one or more memory devices that store programs and information used to run or operate the user device 300. The processor 304 carries out the programs and functions of the user device 300 and communicates with the memory 306 and communication circuitry 308. The processor 304 is operatively connected to communication circuitry 308. The communication circuitry 308 enables the user device 300 to communicate with other devices over a network, such as network 402. The communication circuitry 308 may enable the user device 300 to communicate over wireless protocols, for example, wireless fidelity (Wi-Fi), Cellular, radio frequency (RF), infrared (IR), Bluetooth (BT), Bluetooth Low Energy (BLE), Zigbee, Z-wave and near field communication (NFC). The user device 300 also has a user interface 310 which enables a user to input commands to the user device 300 or receive output. The user interface 310 may include as examples, a touchscreen, virtual or physical buttons, and/or a microphone and speaker. The user interface 310 may also contain a display screen and/or lights for indicating or displaying information to the user.

User device 300 is configured to run application 302 which may be associated with pet access apparatus 10. Application 302 may include features to enable the user to control pet access apparatus 10, including the state of the pet door 102, the cameras 106, 108, etc. Application 302 may also display information regarding the current state and/or condition of pet access apparatus 10, for example, images or a video stream captured by cameras 106, 108. As one example, application 302 may be a graphical user interface instantiated by a web browser through which a user may control door 100 via the internet. As another example, application 302 is a client application and the remote computer 400 is an associated server computer where the client application and server cooperate to control features and functionality of the door 100.

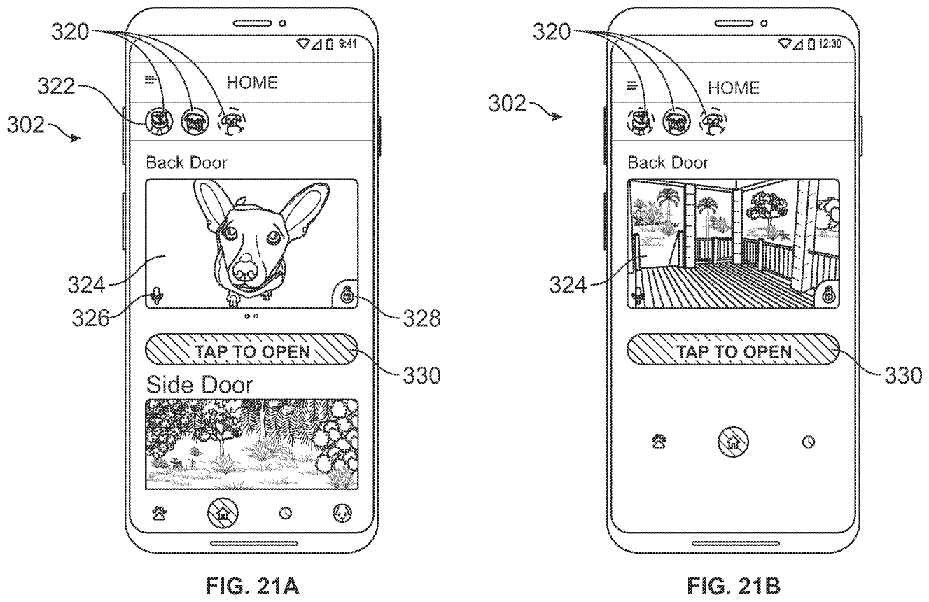

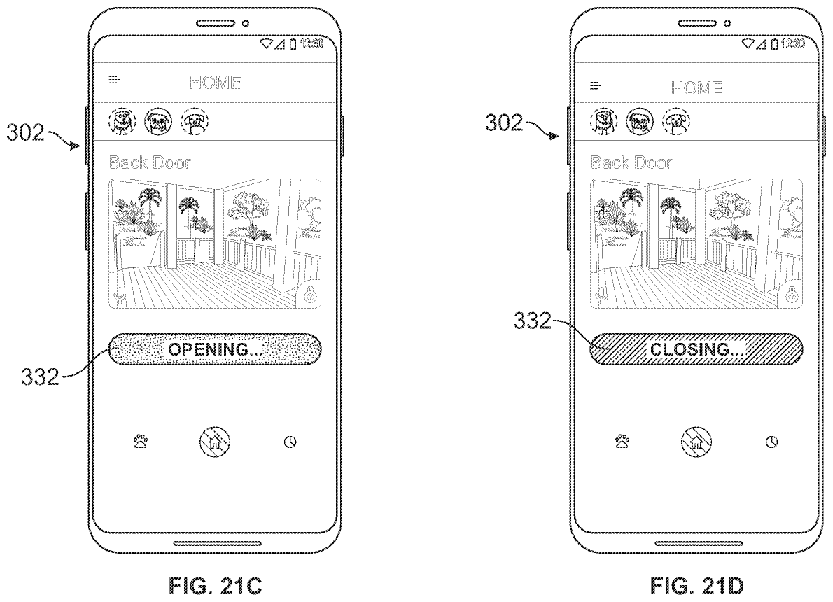

With reference to FIG. 21A-D, screenshots of an example application 302 are shown. A user may create a user account within the application 302. A user may associate each of their pets with their user account via the application 302. For example, a user may associate a pet collar device 200 with a pet and store the association within the application 302. The application 302 may prompt the user to take a photo (e.g., using a camera of the user device 300) and/or upload a photo of the pet to which the pet collar device 200 is attached. The application 302 may include images 320 of each of the pets associated with the pet collar devices 200. The images may indicate to the user whether the pet is inside or outside of the home. In the example shown in FIGS. 21A-D, the images include a ring 322 around the images 320 of the pets to indicate whether the pet is inside or outside of the home.

The user may associate one or more doors 100 with their user account. As shown in FIGS. 21A-B, the user may view the images 324 captured by the interior camera 106 and exterior camera 108 of each door 100 associated with their user account within the application 302. The user may select to talk to their pet by selecting the microphone icon 326 shown at the bottom left of the image 324 captured by pet access apparatus 10. When the user speaks, the user's voice may be played via a speaker 125 of the user interface 122 of the pet access apparatus 10. The user may select the lock icon 328 to lock or unlock the pet door 102. The user may select the “Tap to open” button 330 to send a control signal or command message to the pet access apparatus 10 to cause the pet door 102 to open. As shown in FIGS. 21C-D, the application may indicate that the pet door 102 is opening or closing, for example, via an indicium such as a text box 332.

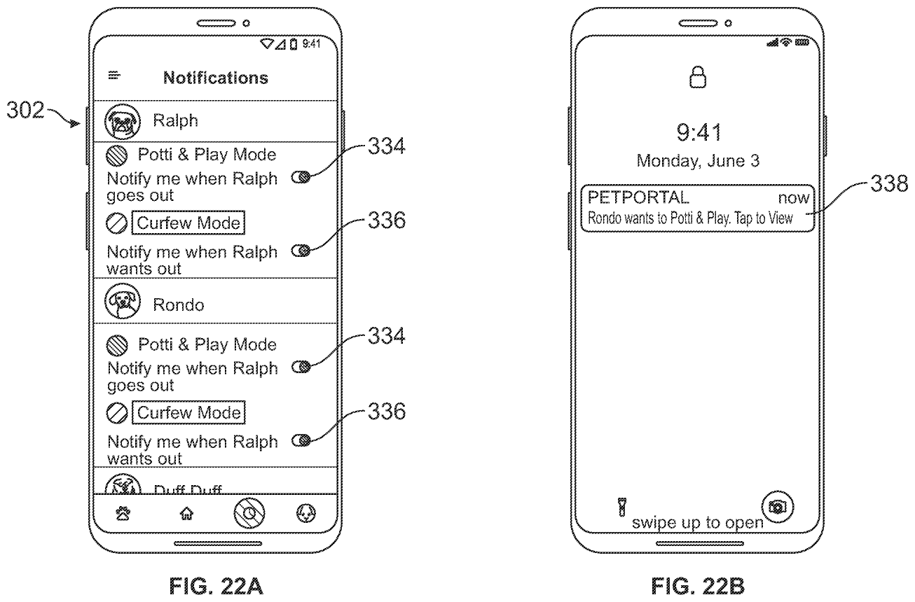

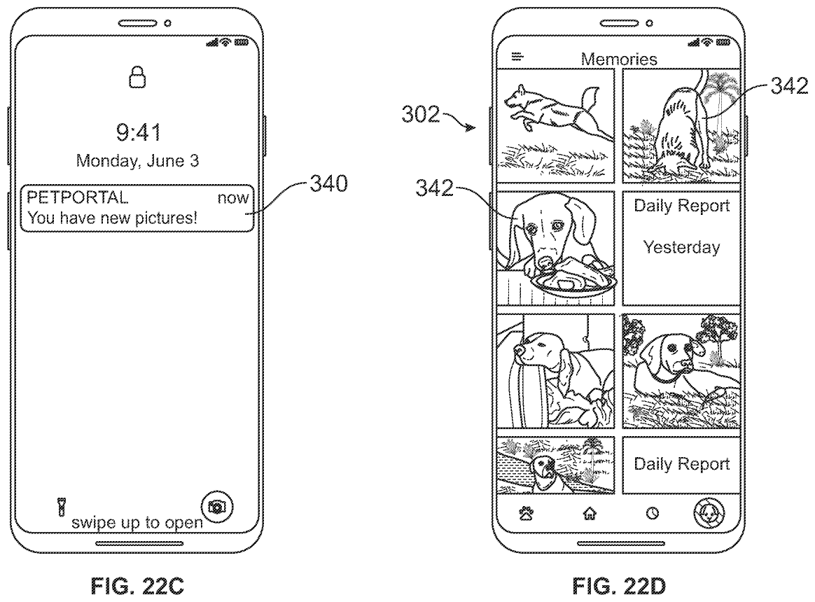

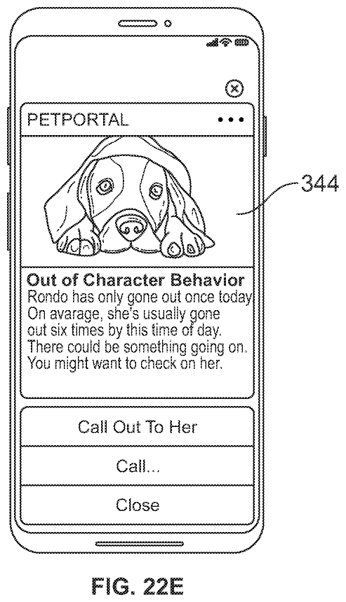

With reference to FIGS. 22A-E, a user may select to receive notifications about their pets via the application 302. As shown in FIG. 22A, the user may select to receive notifications when their pets go out of the house, for example, via a virtual toggle switch 334. The user may further set a time period during which the pets may freely enter and exit the home. For example, the user can setup a curfew mode to lock the pet door 102 or to not open during certain times, e.g., during the night. The user may select to receive notifications when the pet access apparatus 10 or remote computer 400 determines that a pet desires to go outside, for example via a virtual toggle switch 336. Once the user selects to receive notifications that a pet desires to exit the house, and when the pet access apparatus 10 or remote computer 400 determines that the pet wants to exit the home, the user device 300 may receive a notification 338 indicating the same. The user may then decide to open the pet door 102 via the application 302 as described above to allow the pet to exit the home.

A user may select to receive notifications regarding their pets throughout the day. The notification may include images captured by cameras 106, 108 of their pets. As shown in FIG. 22C, an example notification 340 indicating that pictures of the user's pets have been captured. The user may select the notification or open the application 302 on their user device 300 to view the pictures. As shown in FIG. 22D, the application 302 may display images 342 of the pets captured by cameras 106, 108 within the application 302. FIG. 22E shows an example notification 344 when the pet collar device 200, the pet access apparatus 10, and/or the remote computer 400 determines that the pet's behavior is not typical, expected (e.g., based on historical information of the pet's past activities and recognized routines), or normal.

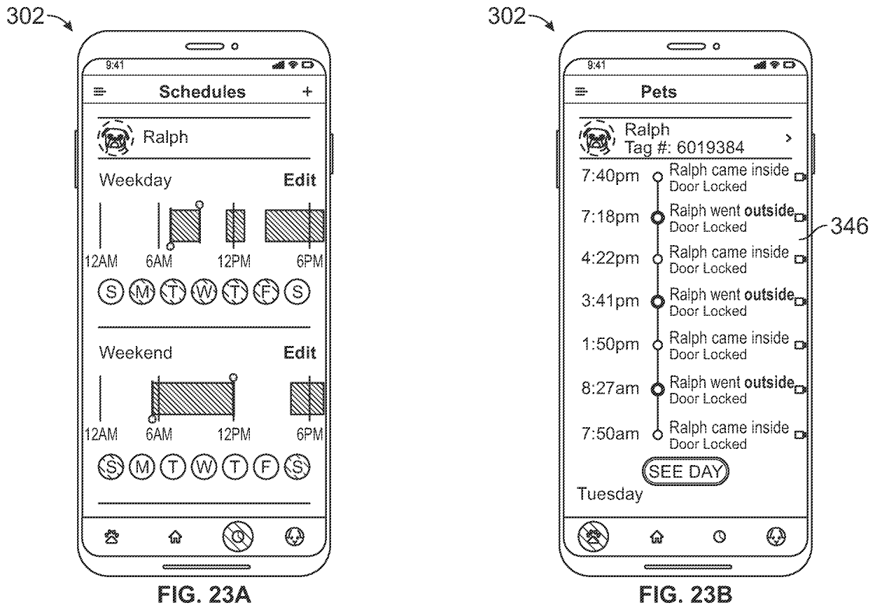

With reference to FIG. 23A-B, a user may set a schedule for each pet, monitor the pet's activity, and receive notifications when the pet's behavior is not normal. As shown in FIG. 23A, a user may set the time when the pet is allowed to pass through the pet door 102. When the pet access apparatus 10 determines that the pet wants to go outside, the pet access apparatus 10 may open the pet door 102 only if the schedule set by the user indicates the pet is allowed to go outside. The user may set a different schedule for each pet and for each day of the week if desired. FIG. 23B shows the activity of a pet. As shown, the application 302 displays a log 346 of the pet passing through the pet door 102, i.e. the pet's comings and goings.

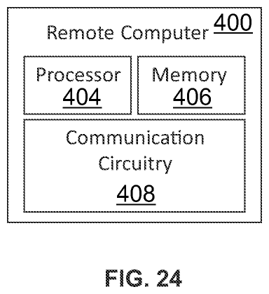

With reference to FIG. 24, the remote computer 400 includes a processor 404 in operative communication with memory 406 and communication circuitry 408. The communication circuitry 408 enables the remote computer 400 to communicate with other devices over the network 402, for example the internet. Specifically, the communication circuitry 408 enables the remote computer 400 to send information to and receive information from the user device 300, pet access apparatus 10, and pet collar device 200. The communication circuitry 408 may also facilitate communications between the remote computer 400 and a third-party service provider such as, for example, a defecation pick-up service or a server configured to control an autonomous terrestrial robot or aerial drone that may pick up and dispose of defecation. The remote computer 400 may be associated with the door 100 and/or the application 302 to control the functionality of the door 100. As one example, the remote computer 400 is a server computer associated with a smartphone application that is configured to control door 100.

The processor 404 may be configured to process information regarding the pet door 102, the pets, and images captured by the cameras 106, 108. The processor 404 may be configured to determine whether a pet desires to enter or exit the home through the pet door 102 based on motion data of the pet collar device 200 and or the images captured by the cameras 106, 108. The processor 404 may apply algorithms to motion data collected and received to determine behavior patterns of the pets, for example. The remote computer 400 may communicate with the user device 300 via communication circuitry 408 and provide application 302 of the user device 300 with information and images to populate the various field within the application 302. The remote computer 400 may send notifications to the user device 300 based on the notification preferences selected by the user within the application 302. The remote computer 400 may also be associated with a website where a user may access the information, images, and notifications relating to door 100 and pets.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A pet access apparatus for a door, the pet access apparatus comprising:
a pet door, the pet door movable between a closed position and an open position;
an actuator coupled to the pet door;
communication circuitry to receive a signal indicative of proximity of a pet to the pet door;
an interior camera operable to capture interior image data;
an exterior camera operable to capture exterior image data; and
a processor operably coupled to the actuator, the communication circuitry, the interior camera, and the exterior camera, the processor configured to:
determine an attempt by the pet to operate the pet door based at least in part on the proximity of the pet to the pet door, the interior image data, and the exterior image data; and
facilitate movement of the pet door from the closed position toward the open position upon the determination of the attempt by the pet to operate the pet door.

2. The pet access apparatus of claim 1 wherein the processor is configured to determine, based at least in part on the exterior image data, whether there is a particular condition outside of the pet door; and
wherein the processor is configured to disregard the attempt by the pet to operate the pet door in response to the particular condition outside of the pet door.

3. The pet access apparatus of claim 2 wherein the particular condition includes at least one of a presence of a predator, a presence of an unauthorized or unknown animal, precipitation, an open gate, a wet yard, and a muddy yard.

4. The pet access apparatus of claim 1 wherein the processor is configured to cause the communication circuitry to send a communication to a remote device upon the processor determining the attempt to operate the pet door;
wherein the communication circuitry is operable to receive a user authorization from the remote device responsive to the communication; and
wherein the processor is configured to facilitate movement of the pet door upon the attempt by the pet to operate the pet door and based upon the communication circuitry receiving the user authorization.

5. The pet access apparatus of claim 1 wherein the processor is configured to configured to determine:
whether the pet is present at one of an interior side and an exterior side of the pet door based on one of the interior image data and the exterior image data; and
whether an unauthorized animal is present at the other of the interior side and the exterior side of the pet door based on the other of the interior image data and the exterior image data.

6. The pet access apparatus of claim 5 wherein the processor is configured to recognize the attempt by the pet to operate the pet door in response to the pet being present at the one of the interior side and exterior side of the pet door and no unauthorized animal being present at the other of the interior side and exterior side of the pet door; and
wherein the processor is configured to disregard the attempt by the pet to operate the pet door in response to the pet being present at the one of the interior side and exterior side of the pet door and the unauthorized animal being present at the other of the interior side and exterior side of the pet door.

7. The pet access apparatus of claim 1 wherein the processor is configured to determine, via at least one of the interior image data and exterior image data, whether the pet is authorized to operate the pet door; and
wherein the processor is configured to disregard the attempt by the pet to operate the pet door in response to the pet not being authorized to operate the pet door.

8. The pet access apparatus of claim 1 wherein the processor is configured to determine, via at least one of the interior image data and the exterior image data, whether an action of the pet corresponds to an action indicating the pet requests the pet door to be opened; and
wherein the processor is configured to disregard the attempt by the pet to operate the pet door in response to the action not indicating the pet requests the pet door to be opened.

9. The pet access apparatus of claim 8 wherein the action of the pet includes at least one of the pet approaching the pet door, the pet being in proximity to the pet door for more than a predetermined length of time, the pet contacting the pet door, and the pet barking.

10. The pet access apparatus of claim 1 wherein the processor is configured to facilitate movement of the pet door by causing the actuator to shift the pet door from the closed position toward the open position.

11. The pet access apparatus of claim 1 wherein the processor includes a processor of a remote computer.

12. The pet access apparatus of claim 1 wherein the communication circuitry is operable to receive weather data; and
wherein the processor is configured to determine whether to disregard the attempt to operate the pet door based at least in part on the weather data.

13. The pet access apparatus of claim 1 wherein the communication circuitry includes a receiver operable to communicate with a radio frequency transmitter associated with the pet.

14. The pet access apparatus of claim 1 wherein the communication circuitry is configured to receive a plurality of signals indicative of proximity of the pet to the pet door; and
wherein the processor is configured to utilize the plurality of signals to determine an angle at which the pet is approaching the pet door; and
wherein the determination of the attempt by the pet to operate the pet door is based at least in part on the angle at which the pet is approaching the pet door.

15. The pet access apparatus of claim 1 wherein the communication circuitry is configured to receive the signal including global navigation satellite system data.

16. The pet access apparatus of claim 1 wherein the processor is configured to facilitate an identification of the pet based on at least one of the interior image data and the exterior image data;
wherein the open position includes a plurality of open positions; and
wherein the processor is configured to facilitate movement of the pet door from the closed position toward the open position including moving the pet door to one of the plurality of open positions based on the identification of the pet.

17. The pet access apparatus of claim 1 further comprising a locking member operably coupled to the actuator, the locking member shiftable between a locked position wherein the locking member inhibits movement of the pet door from the closed position toward the open position and an unlocked position wherein the locking member permits movement of the pet door from the closed position toward the open position; and
wherein the processor is configured to facilitate movement of the pet door including causing the actuator to shift the locking member from the locking position to the unlocked position.

18. The pet access apparatus of claim 1 wherein the processor is configured to automatically facilitate movement of the pet door from the closed position toward the open position in response to the attempt by the pet to operate the pet door.

19. The pet access apparatus of claim 1 wherein the processor is configured to determine, based at least in part on the exterior image data, the attempt by the pet to operate the door and a presence of predator outside of the door; and
wherein the processor is configured to:
cause the actuator to move the pet door from the closed position toward the open position;
determine the pet has traveled through the open pet door; and
cause the actuator to move the pet door from the open position toward the closed position.

20. The pet access apparatus of claim 1 wherein the processor is configured to determine the attempt by the pet to operate the pet door including utilizing at least one of:
a convolutional neural network; and
a histogram of oriented gradients of one or more images.

21. A method of operating a pet access apparatus of a door, the method comprising:
receiving, via communication circuitry, a signal indicative of a proximity of a pet to a pet door of the pet access apparatus;
capturing, via an interior camera, interior image data;
capturing, via an exterior camera, exterior image data;
determining, by a processor, an attempt by the pet to operate the pet door based at least in part on the proximity of the pet to the pet door, the interior image data, and the exterior image data; and
facilitating, by the processor, movement of the pet door from the closed position toward the open position upon the attempt by the pet to operate the pet door.

22. The method of claim 21 further comprising determining based on the exterior image data whether a particular condition is present outside of the pet door; and
disregarding the attempt by the pet to operate the pet door in response to determining the particular condition is present outside of the door.

23. The method of claim 22 wherein the particular condition includes at least one of a presence of a predator, a presence of an unauthorized or unknown pet, precipitation, an open gate, a wet yard, and a muddy yard.

24. The method of claim 21 further comprising:
sending, via the communication circuitry, a communication to a remote device upon the processor determining the attempt to operate the pet door;
receiving, via the communication circuitry, a user authorization from the remote device responsive to the communication; and
facilitating movement of the pet door upon the attempt by the pet to operate the pet door and based upon the received user authorization.

25. The method of claim 21 further comprising:
determining, by the processor, whether the pet is present at one of an interior side and an exterior side of the pet door based on one of the interior image data and the exterior image data; and
determining, by the processor, whether an unauthorized animal is present at the other of the interior side and the exterior side of the pet door based on the other of the interior image data and the exterior image data.

26. The method of claim 25 further comprising:
recognizing, by the processor, the attempt by the pet to operate the pet door in response to the pet being present at the one of the interior side and exterior side of the pet door and no unauthorized animal being present at the other of the interior side and exterior side of the pet door; and
disregarding, by the processor, the attempt by the pet to operate the pet door in response to the pet being present at the one of the interior side and exterior side of the pet door and the unauthorized animal being present at the other of the interior side and exterior side of the pet door.

27. The method of claim 21 further comprising:
determining, by the processor, based on at least one of the interior image data and exterior image data, whether the pet is authorized to operate the pet door; and
disregarding, by the processor, the attempt by the pet to operate the pet door in response to the pet not being authorized to operate the pet door.

28. The method of claim 21 further comprising:
determining, by the processor, via at least one of the interior image data and the exterior image data, whether an action of the pet corresponds to an action indicating the pet requests the pet door to be opened; and
disregarding, by the processor, the attempt by the pet to operate the pet door in response to the action not indicating the pet requests the pet door to be opened.

29. The method of claim 28 wherein the action of the pet includes at least one of the pet approaching the pet door, the pet being in proximity to the pet door for more than a predetermined length of time, the pet contacting the pet door, and the pet barking.

30. The method of claim 21 wherein facilitating movement of the pet door includes causing the actuator to shift the pet door from the closed position toward the open position.

31. The method of claim 21 wherein the processor includes a processor of a remote computer.

32. The method of claim 21 further comprising:
receiving weather data via the communication circuitry; and
determining, by the processor, whether to disregard the attempt to operate the pet door based at least in part on the weather data.

33. The method of claim 21 wherein the signal indicative of a proximity of the pet to the pet door is received from a radio frequency transmitter associated with the pet.

34. The method of claim 21 further comprising:
receiving a plurality of signals indicative of a proximity of the pet to the pet door;
determining, by the processor, an angle at which the pet is approaching the pet door based at least in part on the plurality of signals; and
determining the attempt of the pet to operate the pet door based at least in part on the angle at which the pet is approaching the pet door.

35. The method of claim 21 wherein receiving the signal indicative of a proximity of the pet to the pet door includes receiving global navigation satellite system data.

36. The method of claim 21 further comprising:
facilitating, by the processor, an identification of the pet based on at least one of the interior image data and the exterior image data; and
wherein the open position includes a plurality of open positions; and
wherein facilitating movement of the pet door from the closed position toward the open position includes moving the pet door to one of the plurality of open positions based on the identification of the pet.

37. The method of claim 21 wherein facilitating movement of the pet door from the closed position toward the open position includes causing an actuator to shift a locking member from a locked position to an unlocked position, wherein the locking member inhibits movement of the pet door from the closed position toward the open position with the locking member in the locked position and the locking member permits movement of the pet door from the closed position toward the open position with the locking member in the unlocked position.

38. The method of claim 21 wherein facilitating movement of the pet door includes automatically causing movement of the pet door from the closed position toward the open position in response to the attempt by the pet to operate the pet door.

39-52. (canceled)
